(19) United States
(12) Patent Application Publication
(10) Pub. No.: US 2013/0273855 A1
(43) Pub. Date: Oct. 17, 2013

(54) SYSTEMS, METHODS, AND APPARATUS FOR MACHINE TO MACHINE DEVICE TRIGGERING

(71) Applicant: QUALCOMM INCORPORATED, San Diego, CA (US)

(72) Inventors: George Cherian, San Diego, CA (US); Jun Wang, San Diego, CA (US); Ramachandran Subramanian, San Diego, CA (US)

(73) Assignee: Qualcomm Incorporated, San Diego, CA (US)

(21) Appl. No.: 13/744,753

(22) Filed: Jan. 18, 2013

Related U.S. Application Data
(60) Provisional application No. 61/624,976, filed on Apr. 16, 2012.

(51) Int. Cl. H04W 4/00

(52) U.S. Cl. CPC H04W 4/005
USPC 455/68

(57) ABSTRACT

Systems and apparatus for triggering of machine to machine (M2M) devices (e.g., smart meters) are provided. In one aspect, a method for machine to machine communication is provided. The method includes receiving a device triggering request message from a server. The device triggering request message includes an identifier. The method further includes identifying a machine to machine service layer protocol based on contents of the device triggering request message and the identifier. The method further includes identifying a sensor based at least in part on the identifier. The method further includes sending a message to the sensor as defined by the identified machine to machine service layer protocol. Other aspects, embodiments, and features are also claimed and described.

### CROSS REFERENCE TO RELATED APPLICATION & PRIORITY CLAIM

This application claims priority to and benefit under 35 U.S.C. §119(e) to U.S. Provisional Patent Application No. 61/624,976, entitled “SYSTEMS AND METHODS FOR MACHINE TO MACHINE DEVICE TRIGGERING” filed Apr. 16, 2012, the disclosure of which is hereby incorporated by reference in its entirety as if fully set forth below for all applicable purposes.

### TECHNICAL FIELD

The technology discussed in this application relates generally to communication systems, and more specifically, to triggering methods and devices for machine to machine communications.

### BACKGROUND

In many communication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), or personal area network (PAN).

Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

As networks proliferate, the types of network elements connected thereto also expand. One type of network element is a machine to machine (M2M) element. Examples of M2M elements include a smart utility meter (“smartmeter”), seismographs, vehicles, and appliances. An M2M element may connect to a network through a user equipment (UE) (e.g., smartphone, WiFi router). Accordingly, improvements to communication systems to may be desirable to improve communication via the network, such as communication from an M2M service provider (e.g., utility company) with a connected M2M element.

### BRIEF SUMMARY OF SOME SAMPLE EMBODIMENTS

The methods and devices described each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features described provide advantages that include identification of M2M devices attached to a user equipment.

In one aspect, an implementation of a method for triggering a device is provided.

The method includes receiving a device triggering request message from a server. The device triggering request message includes an identifier. The method further includes identifying a machine to machine service layer protocol based on contents of the device triggering request message and the identifier. The method further includes identifying a sensor based at least in part on the identifier. The method further includes sending a message to the sensor as defined by the identified machine to machine service layer protocol.

In another aspect, a wireless communications apparatus for machine to machine communication is provided. The apparatus includes a receiver configured to receive a device triggering request message from a server. The device triggering request message includes an identifier. The apparatus further includes a processor configured to identify a machine to machine service layer protocol based on contents of the device triggering request message and the identifier and identify a sensor based at least in part on the identifier. The apparatus further includes a transmitter configured to send a message to the sensor as defined by the identified machine to machine service layer protocol.

In yet another aspect, a wireless communications apparatus for machine to machine communication is provided. The apparatus includes means for receiving a device triggering request message from a server. The device triggering request message includes an identifier. The apparatus further includes means for identifying a machine to machine service layer protocol based on contents of the device triggering request message and the identifier. The apparatus further includes means for identifying a sensor based at least in part on the identifier. The apparatus further includes means for sending a message to the sensor as defined by the identified machine to machine service layer protocol.

In another aspect, a computer program product including a computer readable storage medium encoded thereon with instructions that when executed cause an apparatus to perform a method for machine to machine communication is provided. The method includes receiving a device triggering request message from a server. The device triggering request message includes an identifier. The method further includes identifying a machine to machine service layer protocol based on contents of the device triggering request message and the identifier. The method further includes identifying a sensor based at least in part on the identifier. The method further includes sending a message to the sensor as defined by the identified machine to machine service layer protocol.

In another aspect, an implementation of a method for machine to machine communication is provided. The method includes generating a device triggering request message. The device triggering request message includes an identifier and includes information indicative of a machine to machine service layer protocol used at least in part by a wireless device in communication with a sensor. The method further includes transmitting the device triggering request message to the wireless device that is in communication with the sensor.

In another aspect, a wireless communications apparatus for machine to machine communication is provided. The apparatus includes a processor configured to generate a device triggering request message. The device triggering request message includes an identifier and includes information indicative of a machine to machine service layer protocol used at least in part by a wireless device in communication with a sensor. The apparatus further includes a transmitter configured to transmit the device triggering request message to the wireless device that is in communication with the sensor.

In another aspect, a wireless communications apparatus for machine to machine communication is provided. The apparatus includes means for generating a device triggering request message. The device triggering request message includes an identifier and includes information indicative of a machine to machine service layer protocol used at least in part by a wireless device in communication with a sensor. The apparatus further includes means for transmitting the device triggering request message to the wireless device that is in communication with the sensor.

In another aspect, a computer program product including a computer readable storage medium encoded thereon with instructions that when executed cause an apparatus to perform a method for machine to machine communication is provided. The method includes generating a device triggering request message. The device triggering request message includes an identifier and includes information indicative of a machine to machine service layer protocol used at least in part by a wireless device in communication with a sensor. The method further includes transmitting the device triggering request message to the wireless device that is in communication with the sensor.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 shows an exemplary wireless communication system in accordance with some embodiments.

FIG. 2 shows a functional block diagram of an exemplary device that may be employed within the communication system of FIG. 1 according to some embodiments.

FIG. 3 shows a functional block diagram of an exemplary system for machine to machine wireless communication according to some embodiments.

FIG. 4 is a diagram of a message interface for use in a protocol for machine to machine device triggering in accordance with some embodiments.

FIG. 5 is a call flow diagram of an exemplary call flow for machine to machine device triggering in accordance with some embodiments.

FIG. 6 is a call flow diagram of another exemplary call flow for machine to machine device triggering in accordance with some embodiments.

FIG. 7 is a flow chart of an exemplary method for machine to machine device triggering in accordance with some embodiments.

FIG. 8 is a call flow diagram of an exemplary call flow for broadcast machine to machine device triggering in accordance with some embodiments.

FIG. 9 is a call flow diagram of another exemplary call flow for broadcast machine to machine device triggering in accordance with some embodiments.

FIG. 10 is a flow chart of an exemplary method for triggering a device in accordance with some embodiments.

FIG. 11 shows a functional block diagram of another exemplary device that may be employed within the communication system of FIG. 1 according to some embodiments.

FIG. 12 is a flowchart of an exemplary method for triggering a device in accordance with some embodiments.

FIG. 13 shows a functional block diagram of another exemplary device that may be employed within the communication system of FIG. 1 according to some embodiments.

FIG. 14 is a flow chart of an exemplary method for triggering a device in accordance with some embodiments.

FIG. 15 shows a functional block diagram of another exemplary device that may be employed within the communication system of FIG. 1 according to some embodiments.

FIG. 16 is a flow chart of an exemplary method for triggering a device in accordance with some embodiments.

FIG. 17 shows a functional block diagram of another exemplary device that may be employed within the communication system of FIG. 1 according to some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Like reference numerals may be used to denote like features throughout the specification and figures.

### DETAILED DESCRIPTION

Various aspects of the novel apparatuses and methods are described more fully hereinafter with reference to the accompanying drawings. The teachings disclosure may, however, be implemented in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel apparatuses and methods disclosed herein, whether implemented independently of or combined with any other aspect of the disclosure. For example, an apparatus may be implemented or a method may be practiced using any number of the aspects set forth herein. In addition, the scope of the description is intended to cover such an apparatus or method which is practiced using other structure, functionality, or structure and functionality in addition to or other than the various aspects set forth herein. It should be understood that any aspect disclosed herein may be implemented by one or more elements of a claim. The word “exemplary” is used herein to mean “serving as an example, instance, or illustration.” Any embodiment described herein as “exemplary” is not necessarily to be construed as preferred or advantageous over other embodiments.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different communication technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to a communication standard, such as wireless protocols. For example, the various aspects described herein may use Zigbee, WiFi, HomePlug, Bluetooth, Zwave, cellular, or other radio communications.

In some embodiments, a communication network includes various devices which are the components that access the network. For example, there may be two types of devices: access points (“APs”) and clients (also referred to as stations, or “STAs”). In general, an AP serves as a hub or base station for the communication network and a STA serves as a user of the communication network. For example, a STA may be a laptop computer, a personal digital assistant (PDA), a mobile phone, etc. In an example, a STA connects to an AP via a WiFi (e.g., IEEE 802.11 protocol such as 802.11ah) compliant wireless link to obtain general connectivity to the Internet or to other wide area networks.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Router, Transceiver, Hub, or some other terminology.

A station “STA” may also comprise, be implemented as, or be known as an access terminal (“AT”), a subscriber station, a subscriber unit, a mobile station, a remote station, a remote terminal, a user terminal, a user agent, a user device, user equipment, or some other terminology. In some embodiments an access terminal may comprise a cellular telephone, a telephone, a Session Initiation Protocol (“SIP”) phone, a wireless local loop (“WLL”) station, a personal digital assistant (“PDA”), a handheld device, or some other suitable processing device connected to a modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, an appliance, power generating/transmitting equipment, surveillance equipment (e.g., seismograph, smoke detector, Geiger counter, camera), smartmeter, vending machine or any other suitable device that is configured to communicate via a wireless or wired medium in a machine to machine fashion.

Some devices may be used for smart metering, in a smart grid network, or in smart appliances (e.g., appliances configurable in response to transmitted or detected signals). Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine to machine communications.

Prior to communicating with a network, a STA generally registers with a network. Registration may be done at power up, based on zones, based on time (e.g., periodic), or parameter based. For example, in a cdma2000 1x system, a periodic registration system is used to ensure the STA may be reached. In some embodiments, an AP transmits (e.g., broadcasts) a registration period. If a STA has no traffic channel established, or other types of registration (e.g., signaling) during the registration period, the STA is configured to transmit a registration at least one time during the registration period to maintain presence on the network. This form of registration may also be included in EVDO, UMTS, LTE, HRPD, and PPP systems.

In some embodiments, a first STA may provide a service to another STA. For example, a website may be considered a service providing STA wherein the server hosting the website may be the service providing STA. A smartphone accessing the website may be considered the other STA. The smartphone and the website STAs may communicate through one or more APs. The AP connected with the smartphone identifies the smartphone and any communications associated therewith. The identification may be accomplished through a registration protocol. Similar procedure may be used to connect server hosting the website. By this example, the network of APs may be considered under the purview of a network operator. The network operator may control the devices identified to it for example by shaping the network traffic (e.g., latency, priority, bandwidth) or blocking certain traffic (e.g., packet level, source, destination, port, etc.).

As discussed above, networked technologies and network capable devices are becoming more pervasive. In some instances, a device may access a network provided by a network provider through a local host such as a cable modem or mobile hot-spot. In this situation, the cable modem or mobile hot-spot may be configured to identify itself to the network operator to gain access to network services. However, once connected, various devices coupled with the cable modem or mobile hot-spot may use the network services.

One advantage of the systems and methods described herein is to allow a network operator the ability to identify and control these devices accessing an operator's network through devices such as a mobile hot-spot. By identifying not only the user equipment attached to the network (e.g., mobile hot-spot), but also the devices attached to the user equipment, traffic may be more finely controlled. For example, in the machine to machine (M2M) context, it may be desirable to allow a M2M capable fire detector higher priority than, say, a M2M data collection device (e.g., thermometer). The identification also allows the network operator to adjust subscription levels for various devices.

A second advantage of the systems and methods described here is to allow the network operator to locate the device connected to user equipment (UE). In the mobility context, the user equipment may operate on a cellular network. The user equipment may be mobile. In the case where a service provider wishes to send a signal (e.g., a trigger) to a device attached to the user equipment, the network may be configured to identify the location of the UE as well as the device.

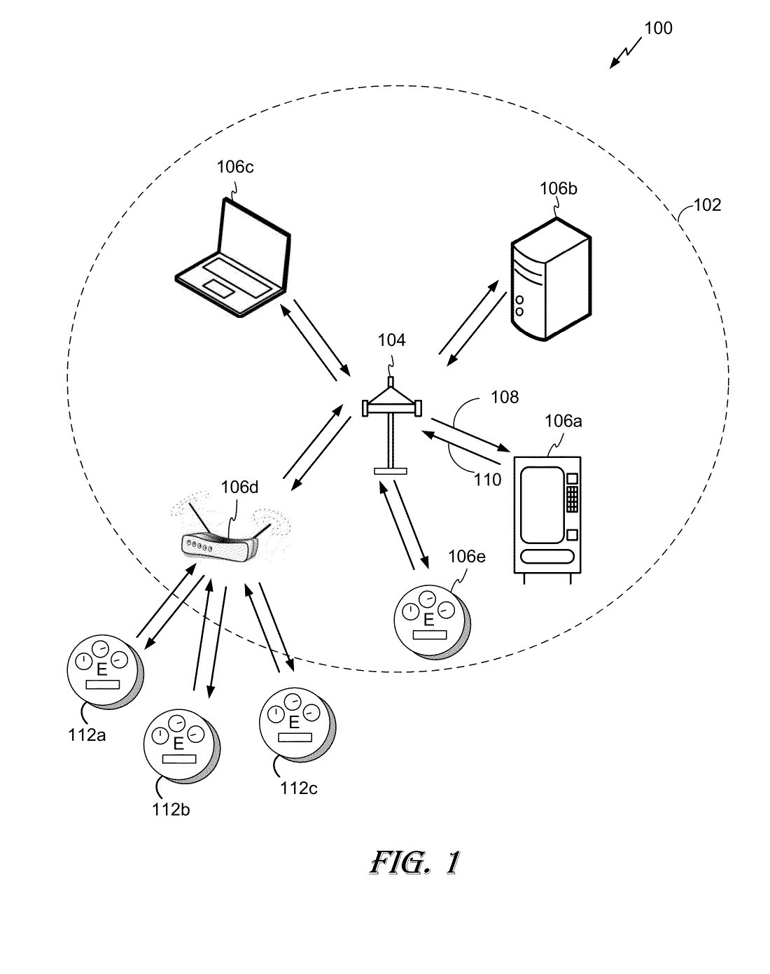

FIG. 1 shows an exemplary wireless communication system, in accordance with some embodiments. The communication system 100 may operate pursuant to a wireless standard. The communication system 100 may include an AP 104, which communicates with STAs such as a computer 106c, a service provider server 106b, a machine to machine device 106a such as a vending machine, a machine to machine device 106e such as a smart utility meter or smart meter, and a local access point (a.k.a. local host) 106d (individually or collectively hereinafter identified by 106). Each STA 106 may be configured to include an identifier. For example, the local access point 106d may include a local host identifier. The local host identifier may be used to identify a local access point 106d. In some embodiments the local host identifier may uniquely identify the local access point 106d. In some embodiments, the local host identifier may be used in conjunction with other information (e.g., network operator) to uniquely identify the local access point 106d. A local host identifier may include an international mobility equipment identity or international mobility subscriber identity.

The local access point 106d may be further configured to communicate with one or more machine to machine devices 112a, 112b, and 112c (collectively or individually hereinafter identified by 112) such as a smart utility meter or a smartmeter. In some embodiments, a machine to machine device 112 may be associated with a machine to machine service provider (e.g., utility company). Each machine to machine device 112 may be configured to include a device identifier. The device identifier may be used to identify a machine to machine device 112. In some embodiments the device identifier may uniquely identify the machine to machine device 112. In some embodiments, the device identifier may be used in conjunction with other information (e.g., network operator, machine to machine service provider) to uniquely identify the machine to machine device 112.

A variety of processes and methods may be used for transmissions in the communication system 100 between the AP 104 and the STAs 106. For example, signals may be sent and received between the AP 104 and the STAs 106 in accordance with OFDM/OFDMA techniques. If this is the case, the communication system 100 may be referred to as an OFDM/OFDMA system. Alternatively, signals may be sent and received between the AP 104 and the STAs 106 in accordance with CDMA techniques. If this is the case, the communication system 100 may be referred to as a CDMA system. In some embodiments, the signals between the AP 104 and the STAs 106 may be sent via a wired connections such as Ethernet, optical, cable, telephone, power line, and facsimile connections.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may provide communication coverage in a basic service area (BSA) 102. The AP 104 along with the STAs 106 associated with the AP 104 and that are configured to use the AP 104 for communication may be referred to as a basic service set (BSS). It should be noted that the communication system 100 may not have a central AP 104, but rather may function as a peer-to-peer network between the STAs 106. Accordingly, the functions of the AP 104 described herein may alternatively be performed by a STA 106. For example, in some embodiments, one or more STAs 106 may be located outside the BSA 102.

In the system 100 shown in FIG. 1, unlike machine to machine device 106a, the machine to machine devices 112a, 112b, and 112c may not be capable of initiating communication with the AP 104. Similarly, the AP 104 may not be able to identify which devices are locally connected to the local host 106d. For example, the AP 104 may receive a communication from the service provider server 106b, such as a demand response signal. This communication may be targeted to a specific smartmeter 112a. Accordingly, in some embodiments it may be desirable to register the specific smartmeter 112a such that the AP 104 may identify the specific smartmeter 112a. This registration process will be described in further detail below.

In another example, the machine to machine device 106e may be an automotive monitoring device included in an automobile. This type of machine to machine device 106e may be configured to communicate via a cellular device in the automobile. However, the machine to machine device 106e may not be located in the same BSA 102 between data transmissions. In this example, one way to communicate with the machine to machine device 106e, is to first locate the cellular device. Accordingly, in some embodiments it may be desirable to configure the AP 104 to locate the specific machine to machine device 106e in a mobility setting. This may allow a service provider server 106b to trigger the device 106e. For example, an automotive manufacturer may be the service provider. By this example, the service provider server 106b may be configured to retrieve diagnostic information from the automotive monitoring device for further processing (e.g., generating maintenance reminders, troubleshooting, quality assurance, etc.).

The communication between the local host 106d and the machine to machine devices 112 may be a local communication protocol. The communication may comprise a wired link between the machine to machine devices 112 and the local host 106d (e.g., Ethernet, power line, telephone cable, coaxial cable). The communication may comprise a wireless link such as Peanut, Zigbee, WiFi, Bluetooth and the like. It should be understood that multiple communication methods may be used to communicate with the various machine to machine devices 112. Furthermore, it will be appreciated that while in FIG. 1 all the machine to machine devices 112 are shown as smartmeters, machine to machine devices of type may be connected through the same local host 106d (e.g., smartmeter, smoke alarm, vending machine, etc.).

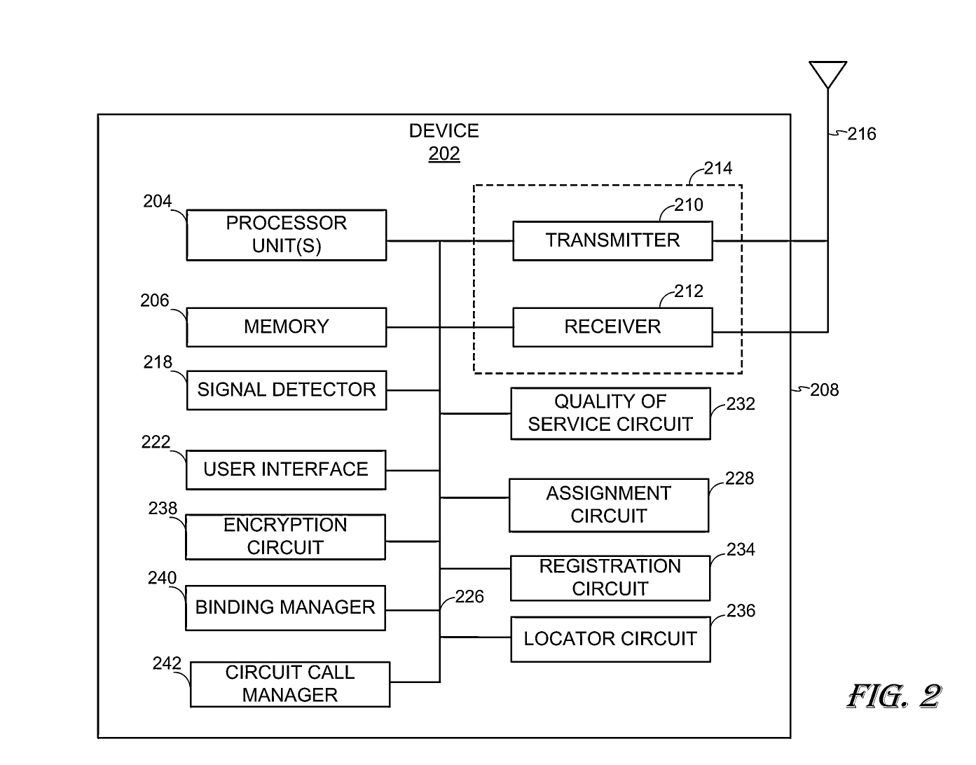

FIG. 2 shows a functional block diagram of an exemplary a device that may be employed within the communication system of FIG. 1. The device 202 is an example of a device that may be configured to implement the various methods described herein. For example, the device 202 may comprise the AP 104, one of the STAs 106, or a machine to machine device 106e.

The device 202 may include processor unit(s) 204 which controls operation of the device 202. One or more of the processor unit(s) 204 may be collectively referred to as a central processing unit (CPU). Memory 206, which may include both read-only memory (ROM) and random access memory (RAM), provides instructions and data to the processor units 204. A portion of the memory 206 may also include non-volatile random access memory (NVRAM). The processor unit(s) 204 may be configured to perform logical and arithmetic operations based on program instructions stored within the memory 206. The instructions in the memory 206 may be executable to implement the methods described herein.

When the device 202 is implemented or used as a transmitting node, the processor unit(s) 204 may be configured to select one of a plurality of packet formats, and to generate a packet having that format. For example, the processor unit(s) 204 may be configured to generate data packets. When the device 202 is implemented or used as a receiving node, the processor unit(s) 204 may be configured to process received packets. The processor unit(s) 204 generates a packet for transmission to one or more STAs 106 or machine to machine devices 112. A packet comprises a series of data bits representing the data being exchanged between an AP 104 and a STA 106/machine to machine device 112.

The processor unit(s) 204 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. In an embodiment where the processor unit(s) 204 comprises a DSP, the DSP may be configured to generate a packet for transmission. In some aspects, the packet may comprise a physical layer data unit (PLDU).

The device 202 may also include machine-readable media for storing software. The processor unit(s) 204 may comprise one or more machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processor unit(s) 204, cause the device 202 to perform the various functions described herein.

The device 202 may include a transmitter 210 and/or a receiver 212 to allow transmission and reception, respectively, of data between the device 202 and a remote location. The transmitter 210 and receiver 212 may be combined into a transceiver 214. An antenna 216 may be electrically coupled with the transceiver 214. The device 202 may also include (not shown) multiple transmitters, multiple receivers, multiple transceivers, and/or multiple antennas.

The transmitter 210 may be configured to wirelessly transmit packets and/or signals. For example, the transmitter 210 may be configured to transmit different types of packets generated by the processor unit(s) 204, discussed above. The packets are made available to the transmitter 210. For example, the processor unit(s) 204 may store a packet in the memory 206 and the transmitter 210 may be configured to retrieve the packet. Once the transmitter 210 retrieves the packet, the transmitter 210 transmits the packet to the device 202 via the antenna 216.

The antenna 216 on the device 202 may detect the transmitted packets/signals. The receiver 212 may be configured to process the detected packets/signals and make them available to the processor unit(s) 204. For example, the receiver 212 may store the packet in memory 206 and the processor unit(s) 204 may be configured to retrieve the packet.

The device 202 may also include a signal detector 218 that may be used in to detect and quantify the level of signals received by the transceiver 214. The signal detector 218 may detect such signals as total energy, energy per subcarrier per symbol, power spectral density, and other signals.

In some aspects, the device 202 may further comprise a user interface 222. The user interface 222 may comprise a keypad, a microphone, a speaker, and/or a display. The user interface 222 may include any element or component that conveys information to a user of the device 202 and/or receives input from the user. The device 202 may also include a housing 208 surrounding one or more of the components included in the device 202.

The device 202 may also include an assignment circuit 228. For example, the assignment circuit 228 may be included in a device 202 implemented as a local access point 106. The assignment circuit 228 may be configured to assign a device connection identifier to each of the device identifiers, the device connection identifier including at least a portion of a local host identifier associated with the local access point 106. For example, when the device 202 is configured to communicate via Ethernet with a machine to machine device 112, the assignment circuit 228 may receive a signal indicating a connection with the machine to machine device 112. The device connection identifier may be a composite identifier (e.g., a device identifier (e.g., IID, MAC-ID) and a connection identifier (e.g., port)). The assignment circuit 228 may maintain a list of communication bindings with the AP 104 (e.g., in memory 206). The assignment circuit 228 may then identify an unused communication binding from the maintained list to be configured for the machine to machine device 112. The assignment circuit 228 may then configure a communication pathway between the Ethernet connection and the unused communication binding. This communication pathway may then be associated with the machine to machine device 112 using the device identifier. The device 202 may refer to the entire binding through the use of a device connection identifier.

The assignment circuit 228 may provide the device connection identifier to the AP 104. For example, the assignment circuit 228 may store the device connection identifier in the memory 206. The transmitter 210 may obtain the device connection identifier and transmit this to the AP 104. In some embodiments, the transmitter 210 may be configured to identify data packets transmitted from the machine to machine device 112 an incorporate the device connection identifier on the packets transmitted from the machine to machine device 116 through the device 202. Accordingly, the AP 104 can identify that a particular packet not only was transmitted by a particular STA, but also that a particular packet was transmitted by a particular device connected to the STA.

The device 202 may also include a quality of service circuit 232. A quality of service circuit 232 may be included in a STA 106, AP 104, or machine to machine device 112. A local access point 106d may include a quality of service circuit 232 configured to perform two levels of quality of service, that is to maintain quality of service between each connected machine to machine device 112 as well as maintain quality of service with the AP 104.

The quality of service circuit 232 may be configured to maintain various operational attributes that affect the quality of the services provided or received. The transmitter 210 and/or receiver may be configured to communicate with the quality of service circuit 232 to control how data is transmitted or received. For example, quality of service circuit 232 may be configured to identify a maximum bandwidth for a particular communication flow. The quality of service information may be stored in the memory 104. The quality of service information may be received from a device providing the service such as a service provider server 106b. In some embodiments, the quality of service circuit 232 may be configured to derive the quality of service information for example based on a device class of the machine to machine device 112. For instance, a device that is in a low priority class such as data reporting device may be assigned lower quality of service during busy periods. Conversely, a device that is in a high priority class such as a smoke detector may be assigned a higher quality of service to ensure an alarm is raised in a timely fashion. In further embodiments, the quality of service circuit 232 may be configured to negotiate quality of service with another device (e.g., machine to machine device 112 negotiating with a local access point 106d, STA 106 negotiating with an AP 104).

In some embodiments, the quality of service may be specified using a tuple. The quality of service tuple may include the device connection identifier. In some embodiments, an RSVP tuple may be used to specify the quality of service information.

The device 202 may also include a registration circuit 234. The registration circuit 234 may be configured to allow the device 202 to access services. For example, when the device 202 is configured as a local access point 106d, the local access point 106d may provide its local host identifier to the AP 104 as part of establishing a communication link therewith. In some embodiments, the local host identifier may be used by the AP 104 to identify machine to machine device bindings for the device. For example, when deploying a smartmeter system, it may be known, a priori, how many meters 112 will be attached to a given local access point 106d. Accordingly, in this embodiment, the local access point 106d may provide its identifier to the AP 104 and the AP 104 may determine the appropriate communication binding for the device. For example, the AP 104 may query a data storage maintained by a service provider to determine the number of meter attached to the identified address. In other embodiments, the AP 104 may be configured to provide a pre-determined number of bindings per local access point 106d. In this embodiment, the AP 104 may consult a subscription registry of local host identifiers and provide the pre-determined number of bindings based on a subscription for local access point 106d. Similar techniques may also be used to provide quality of service information to the quality of service circuit 232.

The device may further include a locator circuit 236. For example when deploying the device 202 as an AP 104, the locator circuit 236 may be configured to identify a location for a local host. The location may be identified based at least in part on one or more of the local host identifier and a device identifier for a machine to machine device 112 attached to the local host. For example, in the mobility example discussed above, it may be desirable to trigger the machine to machine device 112. However, if the machine to machine device 112 is mobile, the location of the STA 106 associated with the machine to machine device 112 may change. The locator circuit 236 may store the location (e.g., home, mobile) of the STA 106. Using the local host identifier and/or the device identifier, the location circuit 236 may be configured to identify the location of the STA 106 (e.g., query).

The device may also include an encryption circuit 238. The encryption circuit 238 may be configured to protect information transmitted from the device 202. For example, the device identifier may be integrity signed by the device 202. This can prevent unauthorized machine to machine devices from “spoofing” as legitimate machine to machine devices 112. The encryption circuit 238 may include a key store to maintain a public or private encryption key, a digital certificate, a synchronization value, a random number generator, or the like. The transmitter 212 may be configured to provide data to the encryption circuit 238 prior to transmission for encryption. Once the data has been encrypted, the encryption circuit 238 may be configured to provide information about the encryption to the transmitter 212 to be transmitted to allow the receiving device to decrypt the information. The encryption circuit 238 may also be configured to decrypt information by reversing the above for a received signal.

The device may also include a binding manager 240. The binding manager 240 may be included in a device 202 when implemented as a local access point 106d or as an AP 104. The binding manager 204 may be configured to receive binding information for the plurality of devices. In some embodiments, the binding manager 204 may be configured determine binding information for each of the one or more machine to machine devices 112 based at least in part on the local host identifier for the local access point 106d. For example, in an embodiment where the AP 104 provides a pre-determined binding assignment to the local access point 106d, the binding manager 240 may be configured to process the binding assignments. In one embodiment, the binding manager 240 includes a memory or is configured to communicate with the memory 240.

The device may also include a circuit call manager 242. The circuit call manager 242 may be included in a device implemented as an AP 104. For example, in an embodiment where a service provider transmits a message to the AP 104 for a machine to machine device 112, the circuit call manager 242 may be configured to initiate a circuit call to the local host. The circuit call manager 242 may include including information identifying the device to be triggered to allow proper routing of the trigger to the machine to machine device 112. In some embodiments, the circuit call manager 242 may be configured to manage cdma2000 1x circuit communications such as circuit calls and short message delivery point-to-point (SMDPP) signaling.

The various components of the device 202 may be coupled together by a bus system 226. The bus system 226 may include a data bus, for example, as well as a power bus, a control signal bus, and a status signal bus in addition to the data bus. Those of skill in the art will appreciate the components of the device 202 may be coupled together or accept or provide inputs to each other using some other mechanism.

Although a number of separate components are illustrated in FIG. 2, those of skill in the art will recognize that one or more of the components may be combined or commonly implemented. For example, the processor unit(s) 204 may be used to implement not only the functionality described above with respect to the processor unit(s) 204, but also to implement the functionality described above with respect to the signal detector 218. Further, each of the components illustrated in FIG. 2 may be implemented using a plurality of separate elements.

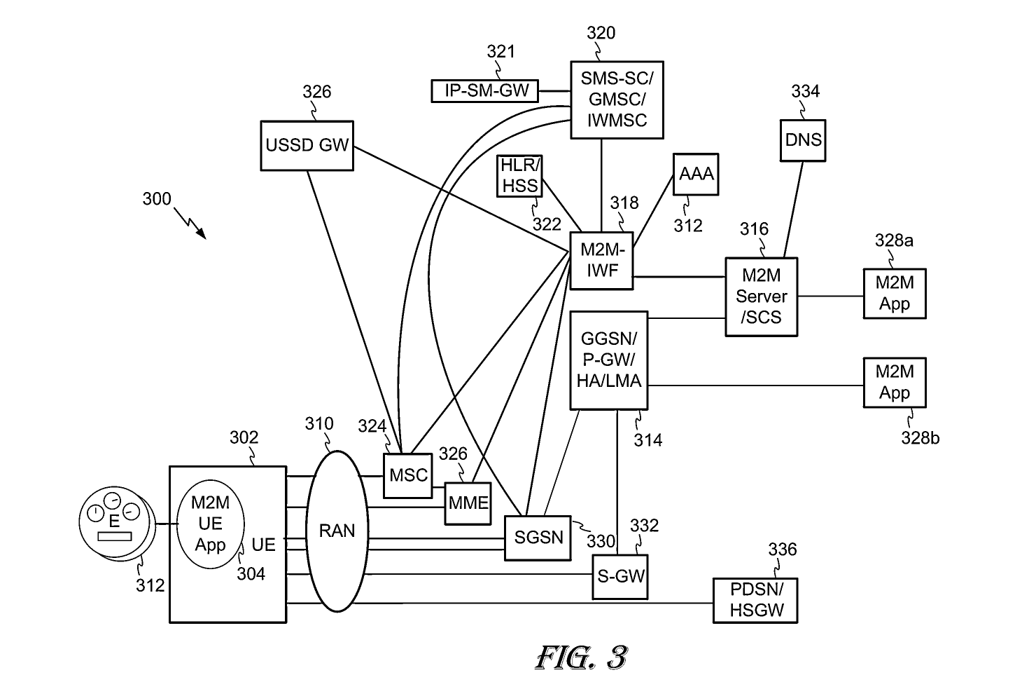

FIG. 3 shows a functional block diagram of an exemplary system for machine to machine wireless communication. The system 300 includes a user equipment (UE) device 302. In some embodiments, the user equipment device 302 may be implemented as local access points such as the local access point 106d of FIG. 1. The user equipment 302 includes a machine to machine application (M2M APP) 304. This machine to machine application 304 may be configured to communicate with a machine to machine application 328a or 328b. Hereinafter, the UE 320 may be referred to as an M2M user equipment (UE) device 302. An M2M UE device 302 may include more than one machine to machine application 304.

When the M2M application 304 is activated in the M2M UE device 302, the M2M application may provide registration information to attach to the user equipment 302. The registration information may include one or more of a device class and a device identifier associated with the M2M application 304. For example, the device identifier may include a media access control (MAC) identifier, or a service provider unique identifier.

The user equipment 302 may be configured to couple with a radio access network (RAN) 310. The radio access network 310 may implement LTE, cdma2000, 1x, or other radio access technology. As part of the coupling, the user equipment 302 may be configured to transmit a local host identifier to the RAN 310 which may be used to route traffic to the user equipment 302.

If the UE 302 is implemented as a local host 106d as shown in FIG. 1, the user equipment 302 may be further configured to assign a device connection identifier to each machine to machine device 112 (FIG. 1) connected with the user equipment 302. In some embodiments, the assignment may be performed at the machine to machine application level. A machine to machine gateway (not shown) in the UE 302 may use this assignment information to send data to and receive data from the machine to machine device 112 (FIG. 1). For example, the machine to machine to machine gateway may ensure the packets include the device connection information prior to transmission to the RAN 310. On the receiving end, when a packet is received from the RAN 310, a portion of the packet (e.g., header field) may be interrogated to obtain the device connection identifier associated with the packet. The machine to machine gateway may then use this device identifier to route the packet to the appropriate machine to machine device 112 (FIG. 1)

In some embodiments, the RAN 310 is coupled with one or more of a Gateway GPRS (General Packet Radio Service) Support Node (GGSN), or Packet Data Network Gateway (P-GW), Home Agent (HA), or a Local Mobility Anchor (LMA) (collectively identified as 314). The GGSN/P-GW/HA/LMA 314 may be connected to the RAN 310 via a serving gateway (S-GW) 332, a serving GPRS support node (SGSN) 330, a packet data serving node (PSDN) 336, or HRPD Serving Gateway (HSGW) 336. The GGSN/P-GW/HA/LMA 314 may be configured to provide a bridge between the radio domain and the packet data domain. The GGSN/P-GW/HA/LMA 314 may perform data communication with a machine to machine (M2M) server 316. The M2M server 316 may also be referred to as a Service Capability Server (SCS). The data communication received by machine to machine server 316 may ultimately be serviced by a machine to machine application 328. In some cases the GGSN/P-GW/HA/LMA 314 may communicate directly with an M2M application 328b. The M2M application 328a and the M2M application 328b may be collectively referred to as an M2M application 328 hereinafter. In some embodiments, the machine to machine server 316 and the machine to machine application 328 are controlled by a machine to machine service provider, such as a utility company or automotive manufacturer as described above.

In some embodiments, such as that shown in FIG. 3, it may be desirable for a service provider to also include a service provider (SP) authentication, authorization, and accounting (AAA) module 312. This module may be implemented as a data storage configured to store usage information for the machine to machine server 316 and/or the machine to machine application 328. For example, as a data packet passes through the machine to machine server 316, the machine to machine server 316 may identify the device connection information associated with the packet. This may allow the machine to machine server 316 to identify the M2M UE device 302 that generated the packet. Based on one or more of authentication, authorization, subscription, and the like, the machine to machine server 316 may process the packet. For example, if the machine to machine device 308 is subscribed for one transaction per week and a second transaction is received, the machine to machine server 316 may block the packet. In this case, the machine to machine server 316 may be configured to transmit a response packet identifying the cause (e.g., subscription exceeded) and/or how to correct the issue (e.g., increasing the subscription level).

In some embodiments, it may be desired to communicate with the M2M UE device 302 via a non-packet switched network. For example, the machine to machine server 316 may transmit information to the machine to machine device using control plane signaling. In this example, the machine to machine server 316 may be configured to communicate with a machine to Machine Interworking Function (M2M-IWF) 318. In some cases the M2M-IWF 318 may be referred to as a machine type communication Interworking Function (MTC-IWF), as machine type communication be another term for machine to machine communication. The Machine to Machine Interworking Function 318 may receive a control plane signal from the machine to machine server 316. In one embodiment, the Machine to Machine Interworking Framework 318 may be coupled with the GGSN/P-GW/HA/LMA 314. In this embodiment, the M2M-IWF 318 may transmit the control signal to the GGSN/P-GW/HA/LMA 314 for delivery as described above. In some embodiments, the M2M-IWF 318 may be further configured to translate the control plane signal into a packet signal for transmission to the GGSN/P-GW/HA/LMA 314.

In some embodiments, the M2M server 316 or the M2M application 328 may transmit data to a machine to machine device 308 via Short Message Service (SMS) messaging. The message may be received by an SMS service controller (SMS-SC) 320. The SMS-SC 320 may also be referred to herein as a Message Center (MC) 320. The SMS-SC 320 may also be a networking switching subsystem (GMSC) or an interworking switching center. The SMS-SC 320 may further communicate with an IP short-message gateway (IP-SM-GW) 321. In this embodiment, the SMS-SC 320 may be configured to receive the message and transmit the message to the IP Anchor GGSN/P-GW/HA/LMA 314. In one embodiment, the SMS-SC 320 may communicate with the M2M-IWF 318 to determine the IP Anchor associated with the intended message recipient. The SMS-SC 320 may then establish a connection with the identified GGSN/P-GW/HA/LMA 314 and transmit the SMS as an IP SMS packet. The IP SMS packet may include one or more of the device identifier, device connection identifier, and the local host identifier associated with the M2M UE device 302 to receive the SMS message. It should be appreciated that other types of messaging services and functions of a message center may be used to send communications to the M2M UE device 302. For example, USSD messaging may be used. As such, a USSD gateway 326 may also be included and configured to communicate with the M2M-IWF 318 and/or the GGSN/P-GW/HA/LMA 314 and MSC 324 for delivering messages.

While the above communication paths have been described as communications originating with the machine to machine server 316 or the machine to machine application 328 and destined for an M2M UE device 302, it will be understood that similar transmission patterns may be implemented to allow the M2M UE device 302 to transmit communication to the machine to machine server 316 or the machine to machine application 328.

In some embodiments, the M2M server 316 and/or the M2M application 328 may push a message to a M2M device 308. For example, if a utility company is the service provider, during high electricity demand periods, the utility company may transmit a demand response signal to smartmeters (M2M device 308) indicating a reduced usage situation has arisen. The smartmeters may be configured, for example, to reduce the usage by disabling certain non-essential appliances. In this case, the location of the M2M device 308 may not necessarily be known.

To communicate with the M2M UE device 302 via the control plane (or otherwise), the M2M-IWF 318 may send information to a mobility switching center (MSC) 324 which may transmit information to the M2M UE device 302 via the RAN 310. In some embodiments, a mobility management entity 326 may be used to communicate between the M2M-IWF 318 and the M2M UE device 302 via the RAN 310. When a UE 302b first registers with the RAN 310, the RAN 310 may transmit a record of the location of the UE 302b to a mobility switching center (MSC) 324/visitor location record. In some embodiments, the RAN 310 may provide the device connection identifier. A corresponding record may be transmitted to a home locator record (HLR)/Home Subscriber Server (HSS) 322. As part of the registration, the RAN 310 may communicate with the AAA 306 to identify whether the M2M UE device 302 may attach to the network, what service level it may be provided, etc. In the context of packet data networks, when the M2M UE device 302 registers with the RAN 310, an IP address may be associated with the M2M UE device 302 and/or the devices attached with the M2M UE device 302.

After registration of the M2M UE device 302, the M2M server 316 may transmit a message for the M2M UE device 302 through one or more communication pathways. Device triggering may be used to provide a message from a machine to machine service provider to a machine to machine device. Device triggering may be used to request that the M2M UE device 302 initiate communications with the M2M server 316. A subsequent communication link may need to be setup as, once the M2M UE device 302 has registered with the M2M server 316, the M2M UE device 302 may not always be operating in a mode for communicating with the M2M server 316. In order to trigger the M2M UE device 302 to initiate operations to establish communications with the M2M server 316, the M2M server 316 sends a device triggering request to the M2M-IWF 318 and in response, the M2M-IWF 318 sends the device triggering request to the M2M UE device 302. When the device triggering request message is received by the M2M UE device 302, the M2M UE device 302 initiates a connection to the M2M server 316. Other operations may be performed by the M2M UE device 302 in response to receiving a device triggering request. For example, the device triggering request message may further comprise one or more commands to the M2M UE device 302 such as for obtaining data from a sensor, for example.

In an embodiment, the M2M server 316 transmits the triggering request to the

M2M-IWF 318. The triggering request may include an external interface identifier such as the device identifier and/or device connection identifier. The M2M-IWF 318 may determine the IP address for the M2M UE device 302 running an M2M application 304 associated with the external interface identifier. The M2M application 304 may be in communication with a machine to machine sensor device 312 as described above with reference to the machine to machine devices 112 of FIG. 1. For example, the M2M-IWF 318 may query one or both of the network operator AAA 306 or service provider AAA (not shown) to identify the appropriate device connection identifier to use for transmitting the triggering request. In the context of packet data connections, the IP address may be used to create a data flow through the GGSN/P-GW/HA/LMA 314 or the appropriate IP anchor for the IP address. This in turn may cause the RAN 310 attached to the M2M UE device 302 to create a data flow for the device trigger. Once established, the data flow may be used for bi-directional packet data communication between the M2M UE device 302 to be triggered and the M2M server 316.

In some instances, the M2M server 316 may need to identify the address of the M2M-IWF 318 to be able to send a device triggering request, for example. As such, the M2M server 316 may be configured to connect to a domain name system (DNS) server 334 to get the network address. Once the M2M server 316 obtains the network address for the M2M-IWF 318, the M2M server 316 may be able to send messages to the M2M-IWF 318.

Certain embodiments described herein are directed to providing an adaptation layer in the network 300 that encapsulates the device triggering request message in an envelope along with relevant header information. In an aspect, the encapsulation may facilitate duplicate detection, segmentation/reassembly, and optional acknowledgement as is further described below. Furthermore, the envelope may be transported via a variety of different communication mechanisms such as CDMA2000 1x, short-message-service (SMS), Internet Protocol (IP), unstructured supplementary service data (USSD), non-access stratum (NAS) signaling, Broadcast SMS, cell broadcasting, Multimedia Broadcast Multicast Service (MBMS), and the like.

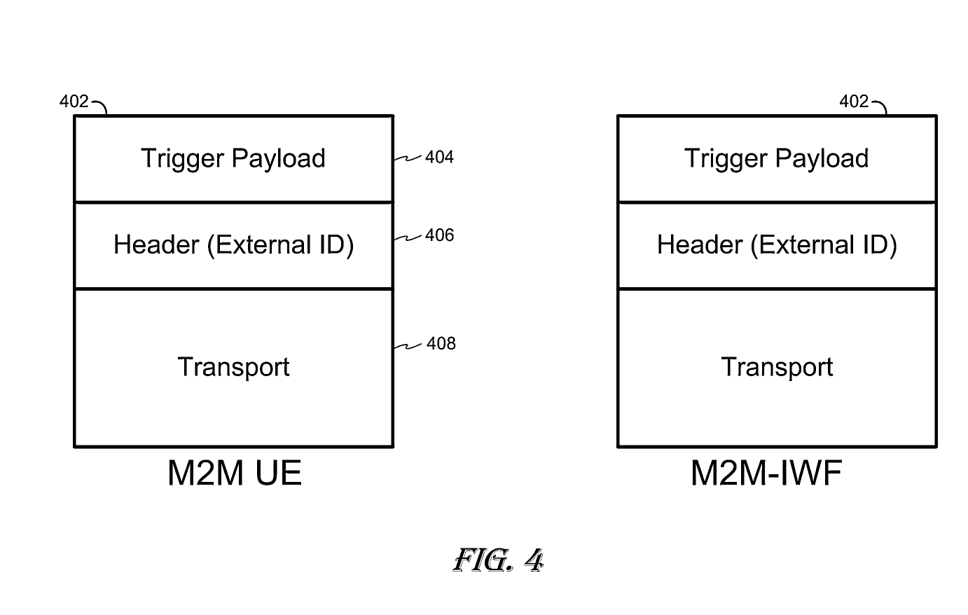

FIG. 4 is a diagram of a message interface 402 for use in a protocol for machine to machine device triggering, in accordance with an embodiment. In accordance with the above, the message interface 402 may allow for providing an adaptation layer for defining how the device triggering request is handled by the M2M application at the M2M UE device 302. The message interface 402 may provide an interface between the M2M UE device 302 and the MTC-IWF 318. In one aspect, this may allow the M2M-IWF 318 to be able select a communication mechanism for transporting the device triggering request message.

The message interface 402 may be provided with a trigger payload 404, a header 406 (including an identifier, ‘external ID’), and a transport 408 mechanism. The transport portion 408 may correspond to the communication mechanism used such as, for example, SMS, IP, Broadcast, USSD, and the like as described above. Data packets or otherwise used for communication for the communication mechanism may encapsulate the trigger payload 404 and header 406. In this way, the device triggering message may be independent of the communication mechanism used for communicating the device triggering request (i.e., transport independent).

The trigger payload 404 is the payload of the device trigger message received from the M2M server 316. The header 406 sent to the M2M UE device 302 from the M2M-IWF 318 may include different information for defining how the M2M UE device 302 will handle the payload 404. For example, the header 406 may include a message type of “trigger” and identifier, ‘external ID.’ The ‘external ID’ may be copied from the message used to communicate the device trigger to the M2M-IWF 318 from the M2M server 316. The header 406 may further include other information such as: a message sequence number, a segment number, a total number of segments, whether an acknowledgment is required or not, segmentation/reassembly information, a recommended communication mechanism for transporting subsequent messages (e.g., IP, SMS, 1xCS, USSD, NAS, cell broadcasting, broadcast SMS, MBMS), security information (encryption and integrity protection as some communication mechanisms for transporting the trigger may not have security), and the like.

As such, in one aspect an additional interface, or new protocol, is provided between the M2M UE device 302 and the MTC-IWF 318. In one aspect, an identifier, such as the ‘external ID’ may be provided. The identifier and/or other information may be used to determine a machine to machine service layer protocol used by the M2M UE device 302 for handling the device triggering message. Once the M2M UE application 304 of the M2M UE device 302 derives the machine to machine service layer protocol from the device triggering message (e.g., from payload 404 and header 406), the M2M UE application 304 may identify the intended sensor based on, for example, the “external ID.” The mechanism and information used to identify the sensor 312 may be defined by the machine to machine service layer protocol.

The M2M UE application 304 sends a message to the sensor 312 according to the identified machine to machine service layer protocol and based on information from the header 406 and the trigger payload 404. In one aspect, the machine to machine service layer protocol may be at least partially defined by the particular configuration of the fields in the header 404. For example, in addition to how to send a message the M2M sensor 312 and what information to include, the machine to machine service layer protocol may further define how acknowledgments are transmitted to the M2M server 316. For example, in one aspect the machine to machine service layer protocol may define that an acknowledgment of the device triggering message is transmitted once the sensor 312 transmits an acknowledgment to the M2M UE application 304 in the M2M UE device 302. In another aspect, the machine to machine service layer protocol may define that an acknowledgment of the device triggering message is transmitted regardless of whether an acknowledgment is received at the M2M UE device 302 from a M2M sensor 312. In another aspect, the machine to machine service layer protocol may define that a timer for sending the acknowledgment is adjusted by a certain amount. In this way, the acknowledgment mechanism is transparent to any intermediate nodes and can be sent in a transport independent manner. The machine to machine service layer protocol may further define how to initiate a communication link with the M2M server 316, for example, such as the communication mechanism to use. In an embodiment, the information for the communication link and the acknowledgment policy may be defined by the header 406.

The messages as shown in FIG. 4 may run over the Internet Protocol (IP) and may use UDP, for example, with a specified port. In addition, if the transport uses the Internet Protocol (IP), a new IP protocol identifier may be provided for an M2M application 304. In addition, the packet may be hard-coded with a predefined source IP address and port.

As described above, the machine to machine service layer protocol may define the acknowledgment mechanisms. This may provide several benefits. For example, it may be desirable not to rely on the acknowledgment provided by a communication mechanism such as SMS. Furthermore, not all communication mechanisms may have an existing acknowledgment mechanism (e.g., broadcast, SMS, cell broadcasting, MBMS). This may create an issue where an acknowledgment is desired but it is preferable or necessary to transmit the device triggering request using a broadcast mechanism without an acknowledgment mechanism. The acknowledgement from the M2M UE device 302 may further include additional information as defined by the identified machine to machine service layer protocol. The acknowledgement message may include a message type of “ack,” a message sequence number, the source (i.e., M2M UE device 302), the destination (i.e., M2M-IWF 318), the transport used by the trigger message to reach the M2M UE device 302, and security (e.g., derived from AKA or GBA etc.). In addition, the M2M UE device 302 may decide the communication mechanism used for transporting the acknowledgment based on several considerations. For example, the communication mechanism identified may be based on whether there is more data to come (e.g. for choosing between a connectionless mechanism or otherwise).

The communication mechanism for the acknowledgment may be different than the one used by the communication mechanism used for delivering the trigger request. For example, the communication mechanism used to provide the device triggering request may be broadcast, multicast, or unicast where each individually may have different mechanisms for sending an acknowledgment or a lack thereof.

FIG. 5 is a call flow diagram of an exemplary call flow for machine to machine device triggering that may be used to provide the adaption layer described for the device triggering request, in accordance with an embodiment. When the M2M server 316 determines to generate a device triggering request for an M2M UE device 302, the M2M server 316 may send the request for delivery of the device triggering request to the M2M-IWF 318. At call 502, the M2M server 316 may optionally query a DNS server 318 to determine the network address of the M2M-IWF 318 if not already stored or known.

At call 504, the M2M server 316 sends the device trigger request to the M2M-IWF 318 for delivery to the M2M UE device 302. The device trigger request includes an identifier, ‘external ID.’ The device trigger request message sent from the M2M server 316 may include a message type such as a “device trigger request.” The device trigger request message further includes the identity of the originator of the message (i.e., the M2M server 316). The device trigger request message further includes the address of the target (M2M-IWF 318). As described above, the address of the M2M may be determined using DNS based on the eternal identity. The device trigger request message further includes a trigger reference number, the external identity of the trigger target (one or more M2M UE devices such as the M2M UE device 302) or the MSISDN, an optional validity period (e.g., end time), an optional priority indicator of the trigger message (default =normal), and an optional payload (transparent data).

The device trigger request message may further include additional proprietary parameters. In one aspect, theses parameters may be specific to a communication protocol, for example one based on 3GPP2 protocols. The device trigger request message further includes hop-by-hop security that may be handled at the transport layer.

Additional parameters may further be added to the device trigger request message that may provide data for sending the device triggering request in a transport independent fashion and to add additional features for defining the machine to machine service layer protocol. In one aspect, the device trigger request message may further include an indication as to whether a delivery acknowledgement required (yes/no). This may be optional where the default is “yes.” The device trigger request message further includes a preferred transport mechanism, for example as either broadcast or unicast. This parameter may be optional as well. If broadcast is preferred, the device trigger request message may include the service category (M2M class) and a trigger delivery area. The device trigger request message further includes an M2M application class parameter (e.g., smart grid, eHealth, etc.) and associated QoS for additional data sent between the M2M UE device 302 and the M2M Server 316. The device trigger request message may further include an indication as to whether there is more data following the trigger. In one aspect, this may be used by the M2M-IWF 318 to select a communication mechanism for transport. The device trigger request message may further include the location of the M2M UE device 302 to be triggered and category (e.g., in case of broadcast being acceptable).

In some embodiments, the device trigger request message may include an indication of a preferred transport mechanism, whether segmentation is permitted, a port member used for SMS, or IP device trigger delivery.

Based on receiving the device trigger request from the M2M server 316, the M2M-IWF 318 performs authorization & load control to determine if the M2M server 316 is authorized to send the request, etc. at call 506. For example, the M2M-IWF 318 may authenticate the trigger source (i.e., the M2M server 316). The M2M-IWF 318 may further verify that the M2M server 316 has not exceeded its quota and verify that the trigger arrival rate is within an authorized limit

Once authorized, the M2M-IWF 318 sends a subscriber information request to the HLR/HSS/AAA 322 at call 508. In some cases, the message may only be needed if the M2M-IWF 318 does not cache the required information. The message to the HLR 322 includes the external identifier, the MSISDN, and the M2M server 316 identifier if received by the M2M server 316. The M2M-IWF 318 waits for a reply from the HLR/HSS/AAA 322. The HLR 322 responds in call 510 with a subscriber information response that includes an internal identifier.

The M2M-IWF 318 may thereafter determine the communication mechanism by which the delivery of the device triggering request to the M2M UE device 302 is to take place as indicated in call 512. The M2M-IWF 318 may select the transport mechanism based on: the internal ID, the M2M UE device 302 registration status, the message priority, the message expiration time, the M2M server 316 preference (e.g., for broadcast/multicast), the network operating conditions, the operator policy, the M2M server 316 agreement with the operator, the M2M UE device 302 subscription, the M2M UE device 302 location, and the like. The M2M-IWF 318 then selects the node (e.g., SMS-SC 320, etc.) that may serve the selected transport and send the device trigger request to the serving node. The M2M-IWF 318 may select multiple communication mechanisms. As such, if multiple serving nodes are selected, each communication mechanism (e.g., lx, SMS, USSD, etc.) may be tried either in parallel, or sequentially (e.g., in priority to try one after another if one or more fails).

Once the delivery mechanism is selected, at call 514, the M2M-IWF 318 may optionally send a device trigger confirm message may be sent to the M2M server 316. In one aspect, the device trigger confirm message may be sent when: the M2M server 316 generates a trigger messages at rate that exceeds the rate assumed by the M2M-IWF 318, the M2M server 316 generates more trigger messages than is authorized, the external identity cannot be mapped to an internal identity, an external identity is not authorized to receive triggers, the M2M server 316 is not authorized to send the trigger message to the destination (as identified by external identity), or the trigger message is sent to the selected serving node (e.g., SMS-SC 320).

The device trigger confirm message may function as an initial acknowledgement of the device trigger request message received from the M2M server 316. The device trigger confirm message may include the message type of, for example, “device trigger confirmation” and may include the trigger reference number. The device trigger confirm may further include the identity of the M2M-IWF 318 (the originator of the message) and the identity of the target of the message (the M2M Server 316). The device trigger confirm further includes a cause value indicating whether the trigger request message was accepted, not authorized, whether the quota was exceeded, whether the rate was exceed, and whether the external identity/MSISDN provided by the M2M server 316 is unknown. The device trigger confirm message may optionally include a back-off timer as well indicating a period in which the M2M server 316 is not to send further messages (e.g., due to congestion). The device trigger confirm message may also include an indication of whether a device trigger report will be provided by the M2M server 316. This may allow the M2M server 316 to be able to take action to either wait for the report or take some other corresponding action.

At block 516, the M2M-IWF 318 may have decided based on the operation in block 512, to select a mechanism 1 for delivery of the trigger. As one example, communication mechanism 1 may be via CDMA2000 1x. In accordance, the M2M-IWF 318 initiates the procedure by which the device trigger request is delivered to the M2M UE device 302 via communication mechanism 1 as shown in call 518. The device trigger delivery procedure for communication mechanism 1 may be via several intermediate entities as described above such as the PDSN/PGW/CGSN 314 and the MSC/SGSN/MME 324. At block 520, the M2M-IWF 318 may select an alternative delivery mechanism 2 if mechanism 1 fails. Or, the M2M-IWF 318 may determine to use both mechanism 1 and 2 in parallel. As one example, communication mechanism 2 may make use of SMS messaging to deliver the device trigger request. As such, at call 520, the M2M-IWF 318 may initiate the procedure to deliver the device trigger via communication mechanism 2.

For example, as stated, in one aspect the communication mechanism 1 may be provided via the SMS-SC 320. As such the device trigger message may be submitted to the SMS-SC 320. The SMS-SC message may include a message type of “submit trigger” and include a transaction identity, an internal identity (e.g., IMSI), the source of the trigger (e.g., the M2M server 316), and a trigger reference number. The source of the trigger and trigger reference number may be provided so that the M2M-IWF 318 may send the message deliver report. The SMS-SC message may further include a validity period (for SMS), a priority (for SMS), a list of serving node identities (optimization to minimize HLR/HSS 322 inquiries), an SMS application port, and a payload.

In response, the SMS-SC 320 may submit a message back to the MTC-IWF 318 to confirm the receipt of the “submit trigger” message. The trigger confirm message may include a message type of “submit trigger confirm” along with a transaction identity to allow for the device trigger report. The trigger confirm message may further include a source of the trigger (M2M server 316) copied from the submit trigger message. The trigger confirm message may further include the trigger reference number (as also copied from the “submit trigger” message).

After the SMS-SC 320 attempts to deliver the trigger, the SMS-SC 320 may provide a message delivery report to the MTW-IWF 318. This may include a message type of “message delivery report” with a cause code, an M2M server 316 identity, and a trigger reference number (requiring the M2M-IWF 318 to keep the state of the message for an extended period).

If the selected communication mechanism provides delivery confirmation, and the M2M server 316 requested delivery confirmation, at call 524, the M2M-IWF 318 may send a device trigger report to the M2M server 316 when the delivery confirmation is received. The device trigger report message includes a message type of “device trigger report” along with an external identifier/MSISDN, and a trigger reference number. The device trigger report message further includes an identifier indicating the identity of the originator of the message (MTC-IWF 318) and the identity of the target of the message (M2M Server 316). The device trigger report message may optionally include the trigger delivery transport method used by the MTC-IWF 318 (e.g., SMS, USSD, IP/User plane based, control plane based, broadcast etc.). The device trigger report message may further include a cause value indicating the result of the attempt to deliver the device trigger request. The cause value may indicate whether the delivery was successful, whether it failed due to the M2M UE device 302 being unreachable, whether the delivery failed due to network congestion, whether the delivery failed for an unknown reason, or whether it was unknown as to whether the trigger was received by the M2M UE device 302 (e.g., because broadcast mode does not provide an acknowledgment). The additional cause values may provide additional information so that the M2M server 316 may take appropriate action (e.g., retry because of congestion, deregister the M2M UE device 302, or wait some period). The device trigger report message may further optionally include a back-off timer to indicate that the M2M server 316 should not send additional messages for reasons such as to avoid congestion, etc. In response to receiving the device trigger report, the M2M server 316 may send a device trigger report confirmation at indicated at call 526.

Thereafter, if delivery was successful, there may be some action in response to the device trigger request received by the M2M UE device 302 as indicated by call 528. For example, the M2M UE device 302 may initiate a communication link with the M2M server 316 for transferring data. In one aspect, this may be done by establishing a PPP session with the PDSN 336 or PDP context with P-GW/GGSN 314 such that the M2M UE device 302 may open an IP data communication with the M2M server 316 over the network 300.

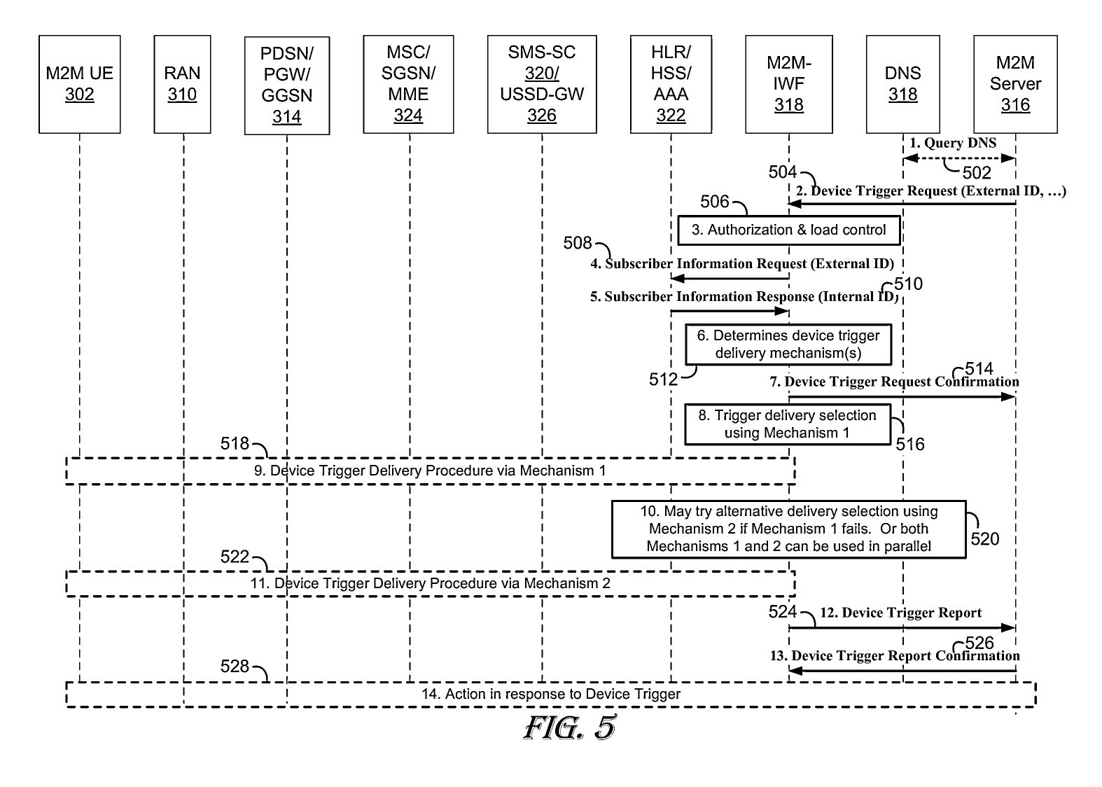

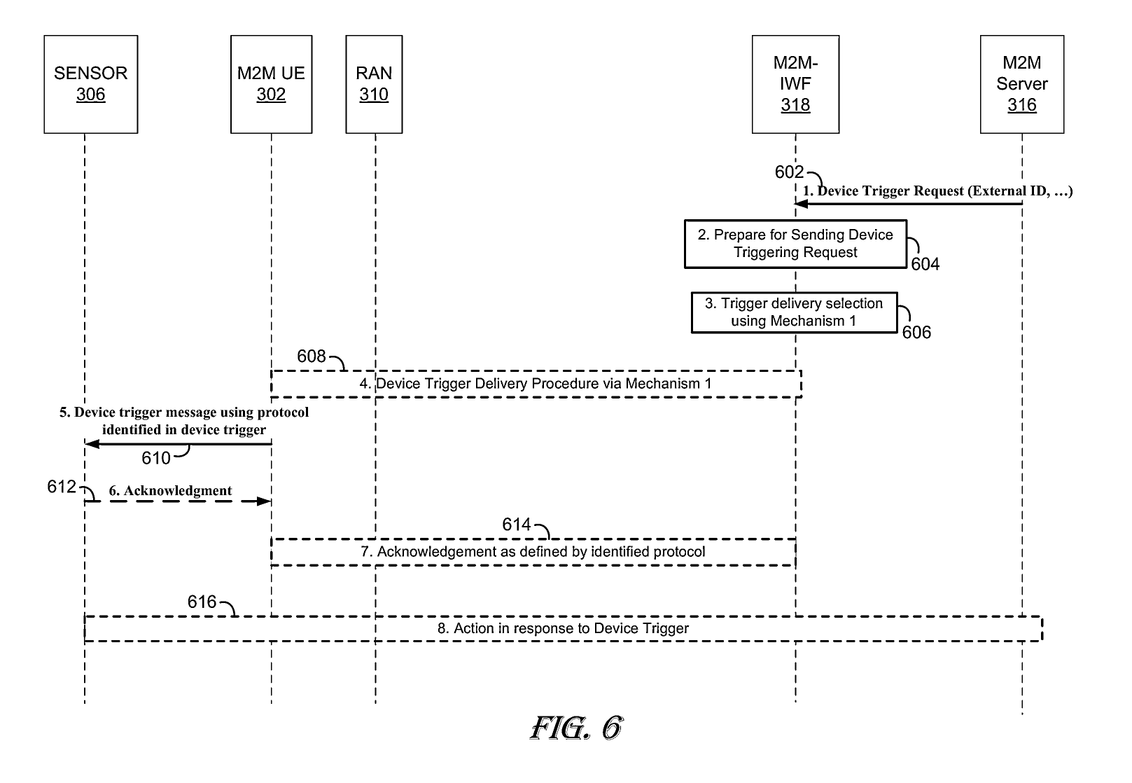

FIG. 6 is a call flow diagram of another exemplary call flow for machine to machine device triggering, in accordance with an embodiment. The call flow diagram of FIG. 6 shows a call flow showing communications that may make use of an identified machine to machine service layer protocol. At call 602, the M2M server 316 sends a device trigger request with an identifier, ‘external ID’ to the M2M-IWF 318 along with information for the trigger payload 404. The M2M-IWF 318 prepares for sending the device triggering request as described, for example, with reference to calls 506-512 of FIG. 5. At call 606 the M2M-IWF 318 selects a communication mechanism for delivering the device triggering request. The device triggering request includes a trigger payload 404 and header 406 as described above with reference to FIG. 4. At call 608, the M2M-IWF 318 performs the device trigger delivery procedure via the selected communication mechanism. Upon receiving the device triggering request at the M2M UE device 302, an M2M application 304 decodes the header and payload and identifies a machine to machine service layer protocol based the information in the device triggering request such as but not limited to an identifier included within the header 406. At call 610 the M2M UE device 302 sends a device trigger message to a M2M sensor 312 using the machine to machine service layer protocol identified. At call 612, an acknowledgment may optionally be sent by the sensor 312. The acknowledgment policy may be determined by the machine to machine service layer protocol identified. At call 614, the M2M UE device 302 sends an acknowledgment as provided by the machine to machine service layer protocol identified. At call 616 some communication may take place between the sensor 312 and the M2M server 316 based in response to the device trigger.

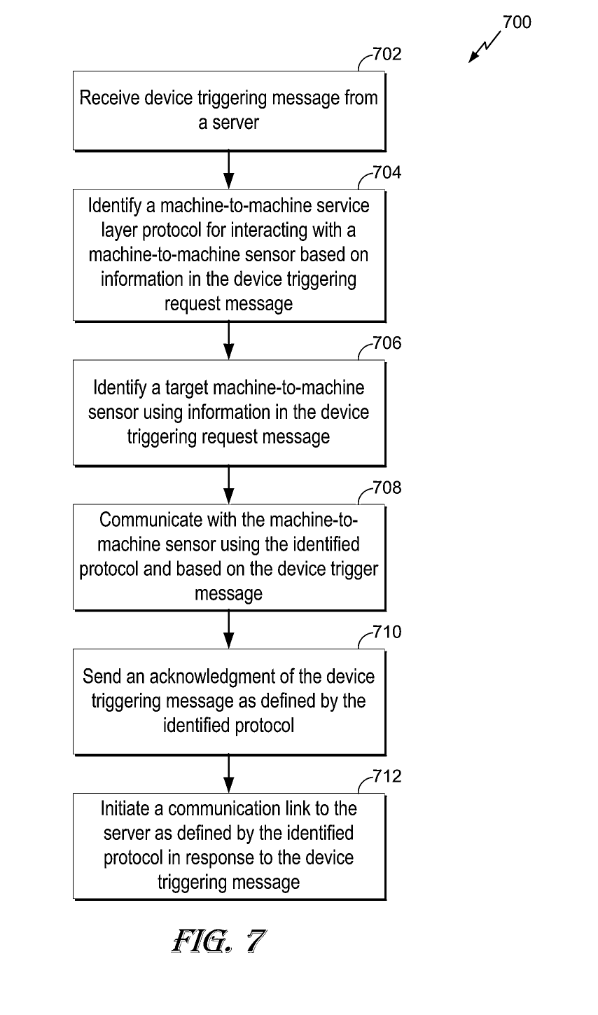

FIG. 7 is a flow chart of an exemplary method 700 for machine to machine device triggering, in accordance with an embodiment. In one aspect, the method 702 may describe how a M2M UE device 302, via the M2M application 302, may identify and use a machine to machine service layer protocol according to a device triggering message. At block 702, a M2M UE device 302 receives a device triggering message from a server, e.g., the MTC-IWF 318 based on messaging with the M2M server 320. At block 704, the M2M UE device 302 identifies a machine to machine service layer protocol for interacting with a machine to machine sensor 312 based on information, such as an identifier, in the device triggering request message. For example, in one aspect, the contents of a header 406 comprising different fields may at least in part define the machine to machine layer protocol for interacting with the machine to machine sensor 312 and handling the device trigger.

At block 706, the M2M UE device 302 identifies a target M2M sensor 312 based on an identifier in the device triggering message. The M2M UE device 302 may identify the M2M sensor 312 using the identified machine to machine service layer protocol and from other information in the device triggering request message. At block 708, the M2M UE device 302 communicates with the M2M sensor 312 using the identified service layer protocol and based on the contents of the device trigger message. For example, the M2M UE device 302 may transmit a command to activate the M2M sensor 312 or may deliver other a data from a payload 404 to the M2M sensor 312. At block 710, the M2M UE device 302 may transmit an acknowledgment of the device trigger message as provided by the machine to machine service layer protocol. As described above, the acknowledgment may be defined based on the acknowledgement policy of the M2M sensor 312 or based on a desired transport mechanism. At block 708, the M2M sensor 312/M2M UE device 302 may initiate a communication link to the M2M server 316 as defined by the identified machine to machine service layer protocol in response to the device trigger.

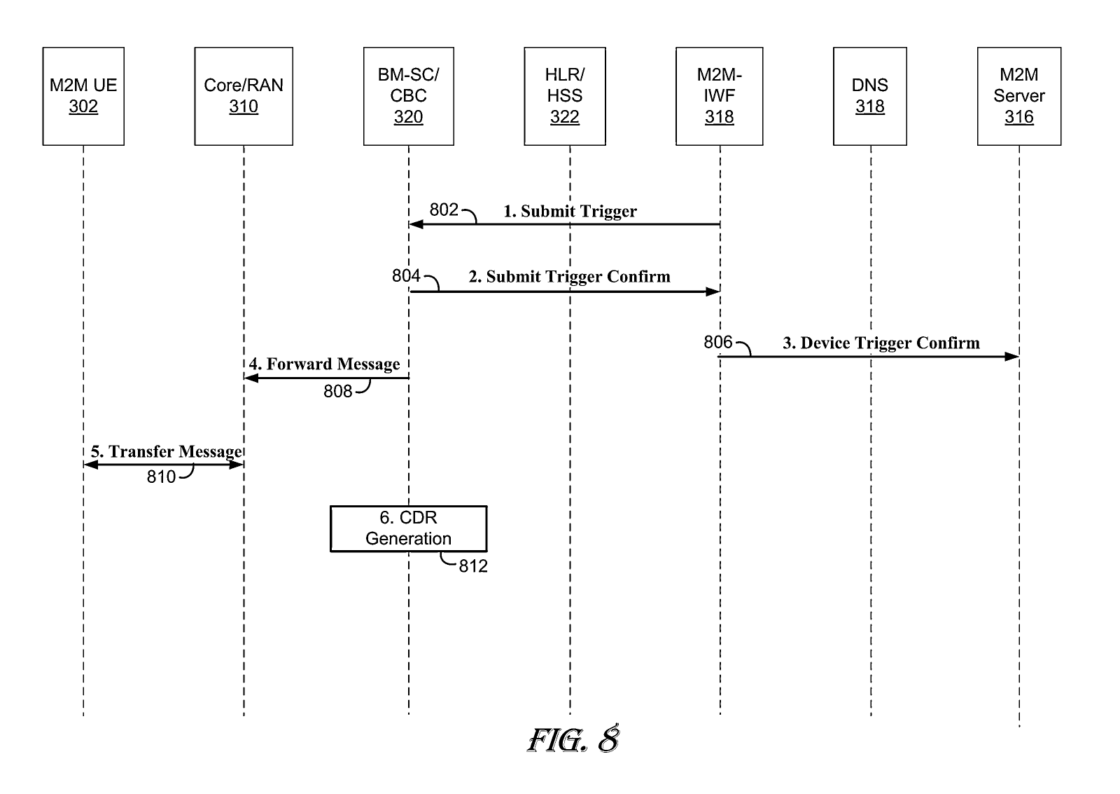

FIG. 8 is a call flow diagram of an exemplary call flow for broadcast machine to machine device triggering, in accordance with an embodiment. As described above, in one aspect, a communication mechanism used to deliver the device trigger request may be sent via a broadcast communication mechanism. For example, the M2M-IWF 318 may determine, as described above, to deliver the message via a broadcast mechanism. At call 802, the M2M-IWF 318 submits the trigger request message to a broadcast multicast service center (BM-SC) 320 or Cell Broadcast Center (CBC) for delivery. Upon receipt of the trigger from the M2M-IWF 318, at call 804, the BM-SC 320 may transmit a trigger confirm message to the M2M-IWF 318. This trigger confirm message may include information similar to the trigger confirm message described above (e.g., with the message type of “submit trigger confirm,” etc.). At call 806, the M2M-IWF 318 may submit a device trigger confirm message to the M2M server 316. In one aspect, the device trigger confirm message may include some of the information described above with respect to the device trigger confirm message sent from the M2M-IWF 318 to the M2M server 316. After transmitting the trigger confirm message, the BM-SC 320 may forward the message for delivery to the RAN 310 at call 808. The RAN 310 may the deliver the message to the M2M UE device 302 at call 810. In the process, the BM-SC 320 may perform charging data record (CDR) generation.

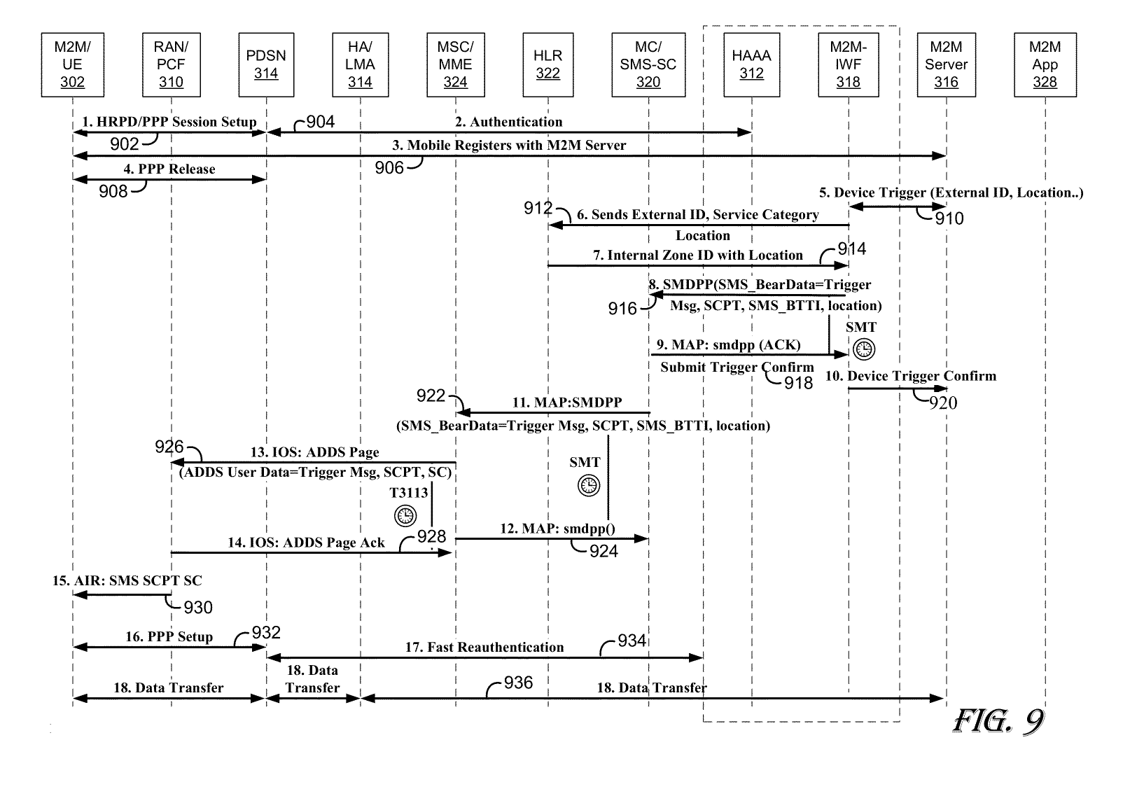

FIG. 9 is a call flow diagram of another exemplary call flow for broadcast machine to machine device triggering, in accordance with an embodiment. FIG. 9 provides an example of using short message service (SMS) as a broadcast mechanism in accordance with the call flow of FIG. 6. As such, in one aspect broadcast SMS may be used. In this case, a value for a Service Category may be defined for M2M device triggering so that when the SMS parser receives the indication to send the M2M triggering SMS, it may route it to the M2M handler within the MC/SMS-SC 320. The MSC/MME 324 may use the broadcast common channel to send the triggering message. In this case, the M2M-IWF 318 may send the external ID, service category, and location to the HLR 322 to receive, in response, an internal location (e.g., internal zone ID) that may be used for example to indicate the location for broadcasting the trigger device request.

Accordingly, initial M2M device registration for any one of multiple M2M devices as shown in calls 902, 904, 906, and 908 may occur. For example, call 902 may be associated with a data-session-registration phase which may be a one time event when the M2M UE device 302 moves to a different subnet (e.g., HRPD/PZID(1x)). At call 904, the PDSN 314 may send the subnet ID (HRPD) or PCF_ID (1x) and the IMSI to the HAAA 306 during authentication and authorization. AT call 906, the device registers with the M2M server 316. At call 608, the PPP session is torn down and the IP address is released.

At call 910, the M2M server 316 may send a device trigger to the M2M-IWF 318 indicating that a device triggering request should be broadcast to one or more M2M devices. The message may include some sort of location information regarding the M2M UE device 302 desired to be triggered. In one aspect, the message may include information as indicated by the device trigger message as described above with respect to FIG. 4. At calls 912 and 914, the M2M-IWF 318 may query the HLR 322 with the external ID, service category, and location for the broadcast M2M device triggering and receive internal location information via an Internal Zone ID for the broadcast M2M device triggering from the HLR 322. The service category may be defined to correspond to a mode for broadcasting an SMS message including a device triggering request to one or more M2M devices. At call 914, the M2M-IWF 318 sends broadcast SMS request for device triggering to the MC/SMS-SC 320 using an MAP SMDPP INVOKE message with SMS_BearData set to trigger message that includes the triggering message, the broadcast teleservice (SCPT), and the SMS_BTTI indicating the service category (SC) received from the HLR 322. The MC/SMS-SC 320 further receives location information for the M2M UE device 302. For example, this may correspond to the submit trigger message as described above with reference to call 802 of FIG. 8. At this point the M2M-IWF 318 may start the SMT. At call 918, the MC/SMS-SC 320 acknowledges the SMDPP message to the M2M-IWF 318 at which point the SMT may stop if the acknowledgement is received. For example, this may correspond to the submit trigger confirm message as described above with reference to call 804 of FIG. 8. As such, the message may include the information described above with reference to FIG. 5 regarding the trigger confirm message sent by the MC 320 to the M2M-IWF 318. At call 920, the M2M-IWF 318 may send a device trigger confirm message to the M2M server 316. This may correspond to the device trigger confirm message as described above with reference to call 806 of FIG. 8. As such, the device trigger confirm message may include the information as described above with the device trigger confirm message with respect to FIG. 5.

At call 922, the MC/SMS-SC 320 constructs a MAP SMDPP INVOKE message with SMS_BearData parameter including a triggering message, broadcast SCPT teleservice, and service category and sends the message to the MSC/MME 324. At this point, the MC/SMS-SC 320 may start an SMT. When the MSC/MME 324 receives the SMDPP INVOKE message, the MSC/MME 324 may determine if broadcast M2M device triggering is authorized and sends an empty MAP smdpp at call 922 to the MC/SMS-SC 320 at which point the SMT may be stopped by the MSC/MME 324.

At call 924, the MSC/MME 324 determines if broadcast M2M device triggering is authorized. The MSC/MME 324 then constructs an IOS ADDS Page that includes the triggering message, the broadcast teleservice, and service category. The data burst type of the ADDS User Data Informational Element is set to SMS. The SMS-BearData parameter of the MAP SMDPP INVOKE is used to create the Application Data Message of the ADDS User Data Informational Element. The MSC/MME 324 sends the IOS ADDS page to the RAN/PCF 310. In one aspect, the calls 922, 924, 926, and 928 may correspond to the call 808 as described above with reference to FIG. 8. The MSC/MME 324 may start a timer T3113 based on the paging request. When the RAN/PCF 310 receives the IOS:ADDS Page message, at call 928, the RAN/PCF 310 sends an acknowledgment message via a IOS:ADDS Page Ack to the MSC/MME 324. At that point the MSC/MME 324 may stop the timer T3113. The RAN/PCF 310 then transmits the broadcast triggering message over the common channel at call 930. In one aspect, this may correspond to call 810 of FIG. 8.

In response to receiving the device trigger request, the M2M UE device 302 of the broadcast group may initiate a communication link with the M2M server 316 by establishing a PPP session or like session and proceed with transferring data with the M2M server 316 in calls 932, 934, and 936. For example, at call 932, the M2M UE device 302 may perform a PPP setup with the PDSN 314, perform authentication at call 934, and then be able to open up a communication pathway to the M2M server 316 at call 936 to perform data transfer.

In one aspect, as described above, the broadcast message received at the M2M UE device 302 may correspond to the message described above with reference to FIG. 5. The M2M UE device 302, in response to receiving the broadcast, may determine to send an acknowledgment to the M2M server 316 of receipt of the trigger, albeit the broadcast does not provide its own mechanism for acknowledgment. As such, the M2M server 316 may determine a communication mechanism to deliver an acknowledgment that is different than the broadcast mechanism.

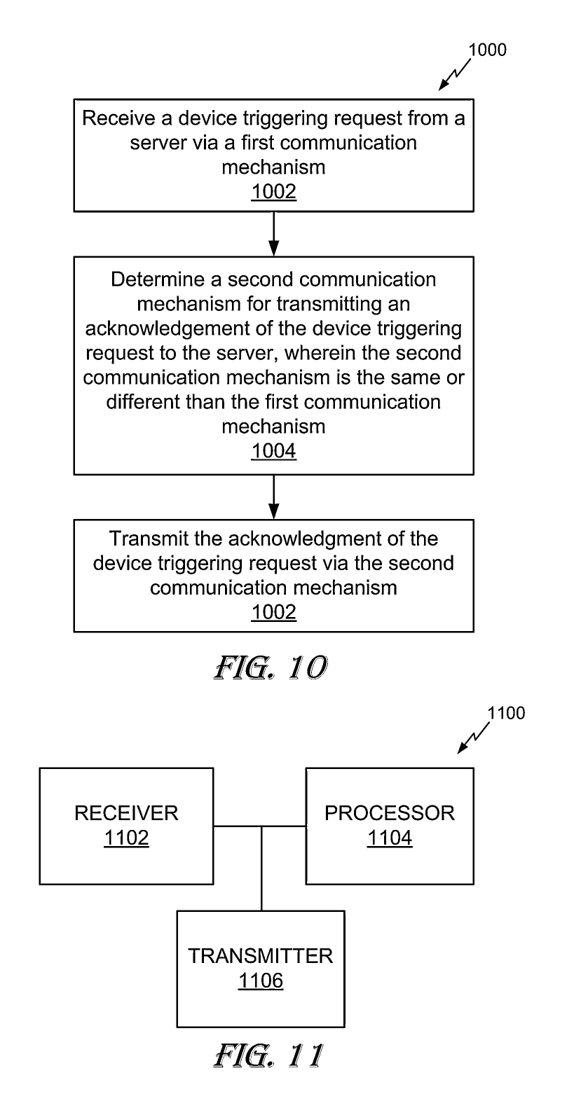

FIG. 10 is a flow chart of an exemplary method 1000 for triggering a device, in accordance with an embodiment. The method shown in FIG. 10 may be implemented, for example, using the device as described above in FIG. 2 or below in FIG. 10. At block 1002, an M2M UE device 302 receives a device triggering request from a server 316 via a first communication mechanism. At block 1004, the M2M UE device 302 determines a second communication mechanism for transmitting an acknowledgment of the device triggering request to the server 316. The second communication mechanism is the same as or different than the first communication mechanism. At block 1006, the M2M UE device 302 transmit the acknowledgment of the device triggering request via the second communication mechanism.

FIG. 11 shows a functional block diagram of another exemplary device that may be employed within the communication system of FIG. 1. Those skilled in the art will appreciate that a wireless communication device may have more components than the simplified wireless communication device 1100 shown in FIG. 11. The wireless communication device 1100 shown includes only those components useful for describing some prominent features of certain embodiments. The wireless communication device 1100 includes a receiver 1102, a processor 1104, and a transmitter 1106.

The receiver 1102 may be configured to receive a device triggering request from a server 316 via a first communication mechanism. The receiver 1102 may include one or more of a memory, a processor, and a signal detector. In some embodiments the means for receiving includes a receiver 1102.

The processor 1104 may be configured to determine a second communication mechanism for transmitting an acknowledgment of the device triggering request to the server 316. The second communication mechanism is the same as or different than the first communication mechanism. In some embodiments, the means for determining may include the processor 1104.

The transmitter 1106 may be configured to transmit the acknowledgment of the device triggering request via the second communication mechanism. The transmitter 1106 may include one or more of a memory, a processor, and a signal detector. In some embodiments the means for transmitting includes a transmitter 1106.

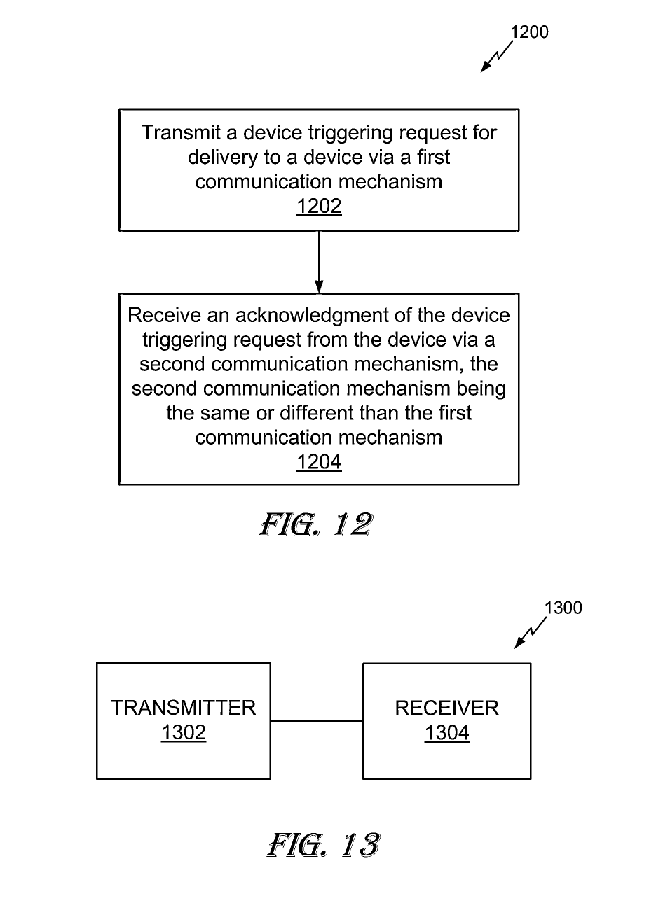

FIG. 12 is a flowchart of an exemplary method 1200 for triggering a device, in accordance with an embodiment. The process shown in FIG. 12 may be implemented, for example, using the device as described above in FIG. 2 or below in FIG. 13. At block 1202, a M2M server 316 may transmit a device triggering request for delivery to a device via a first communication mechanism. At block 1204, the M2M server 316 may receive an acknowledgment of the device triggering request from the device via a second communication mechanism. The second communication mechanism is the same or different than the first communication mechanism.

FIG. 13 shows a functional block diagram of another exemplary device 1300 that may be employed within the communication system of FIG. 1. Those skilled in the art will appreciate that a wireless communication device may have more components than the simplified wireless communication device 1300 shown in FIG. 12. The wireless communication device 1300 shown includes only those components useful for describing some prominent features of certain embodiments. The wireless communication device 1300 includes a receiver 1302 and a transmitter 1304.

The transmitter 1302 may be configured to transmit a device triggering request for delivery to a device (e.g., M2M UE device 302) via a first communication mechanism. The transmitter 1302 may include one or more of a memory, a processor, and a signal detector. In some embodiments the means for transmitting includes a transmitter 1302.

The receiver 1304 may be configured to may receive an acknowledgment of the device triggering request from the device (e.g., M2M UE device 302) via a second communication mechanism. The second communication mechanism is the same or different than the first communication mechanism. In some embodiments, a means for receiving may include the receiver 1304.

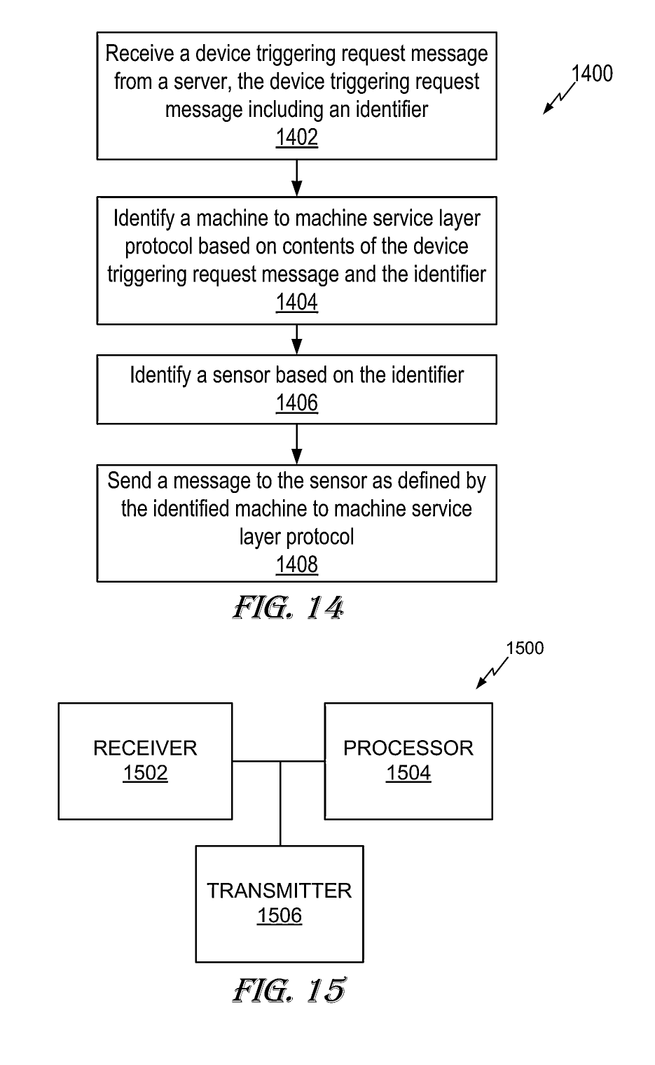

FIG. 14 is a flow chart of an exemplary method 1400 for triggering a device, in accordance with an embodiment. The method shown in FIG. 14 may be implemented, for example, using the device 202 as described above in FIG. 2 or below in FIG. 15. At block 1402, an M2M UE device 302 receives a device triggering request from a server 316. The device triggering request includes an identifier. At block 1404, the M2M UE device 302, via for example an M2M application 304, identifies a machine to machine service layer protocol based on contents of the device triggering request message and the identifier. At block 1406, the M2M UE device 302 identifies a sensor based on the identifier. At block 1408 the M2M UE device 302 sends a message to the identified sensor as defined by the identified machine to machine service layer protocol.

FIG. 15 shows a functional block diagram of another exemplary device that may be employed within the communication system of FIG. 1. Those skilled in the art will appreciate that a wireless communication device may have more components than the simplified wireless communication device 1500 shown in FIG. 15. The wireless communication device 1500 shown includes only those components useful for describing some prominent features of certain embodiments. The wireless communication device 1500 includes a receiver 1502, a processor 1504, and a transmitter 1506.

The receiver 1502 may be configured to perform one or more of the functions as shown in in block 1402 of FIG. 14. The receiver 1502 may include one or more of a memory, a processor, and a signal detector. In some embodiments a means for receiving includes a receiver 1502.

The processor 1504 may be configured to perform one or more of the functions as shown in blocks 1404 and 1406 of FIG. 14. In some embodiments, a means for identifying may include the processor 1504.

The transmitter 1506 may be configured to perform one or more of the functions as shown in block 1408 of FIG. 14. In some embodiments a means for transmitting includes a transmitter 1506.

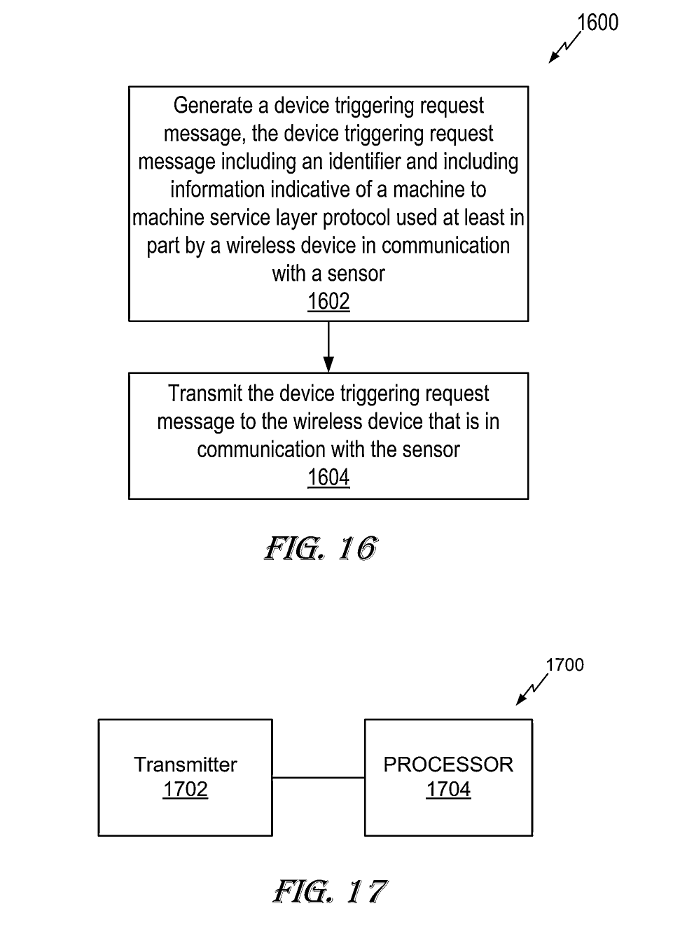

FIG. 16 is a flowchart of an exemplary method 1600 for triggering a device, in accordance with an embodiment. The method shown in FIG. 16 may be implemented, for example, using the device 202 as described above in FIG. 2 or below in FIG. 17. At block 1602, a M2M-IWF 318 generates a device triggering request message. The device triggering request message includes an identifier and includes information indicative of a machine to machine service layer protocol used at least in part by a wireless device in communication with a sensor 312. At block 1604, the M2M-IWF 318 transmits the device triggering request message to the wireless device that is in communication with the sensor 312.

FIG. 17 shows a functional block diagram of another exemplary device that may be employed within the communication system of FIG. 1. Those skilled in the art will appreciate that a wireless communication device may have more components than the simplified wireless communication device 1700 shown in FIG. 17. The wireless communication device 1700 shown includes only those components useful for describing some prominent features of certain embodiments. The wireless communication device 1700 includes a transmitter 1702 and a processor 1404.

The processor 1704 may be configured to perform one or more of the functions as shown in block 1602 of FIG. 16. In some embodiments, a means for generating may include the processor 1704.

The transmitter 1702 may be configured to perform one or more of the functions as shown in in block 1604 of FIG. 16. The transmitter 1702 may include one or more of a memory, a processor, and a signal detector. In some embodiments, a means for transmitter includes a transmitter 1702.

While the method for delivering the device trigger request to the M2M UE device 302 has been referred to herein in some aspects as a communication mechanism, in some aspects, a communication mechanisms may also be referred to as a communication protocol, or communication method.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for machine to machine communication, the method comprising:
receiving a device triggering request message from a server, the device triggering request message comprising an identifier;
identifying a machine to machine service layer protocol based on contents of the device triggering request message and the identifier;
identifying a sensor based at least in part on the identifier; and
sending a message to the sensor as defined by the identified machine to machine service layer protocol.

2. The method of claim 1, wherein identifying the sensor further comprises identifying the sensor based on the identifier and as defined by the machine to machine service layer protocol.

3. The method of claim 1, further comprising sending an acknowledgement of the device triggering request to the server as defined by the machine to machine service layer protocol identified.

4. The method of claim 3, wherein sending the acknowledgement as defined by the machine to machine service layer protocol comprises at least one of sending the acknowledgement after receiving another acknowledgement from the sensor, sending the acknowledgment before sending the device triggering request to the sensor, and adjusting a timer value for sending the acknowledgment.

5. The method of claim 1, wherein the device triggering request message is encapsulated in a data packet as defined by a communication protocol used to receive the device triggering request.

6. The method of claim 5, wherein the communication protocol comprises one of an Internet protocol (IP), short-message-service (SMS), unstructured supplementary service data (USSD), CDMA2000 1x, non-access stratum (NAS) signaling, broadcast SMS, cell broadcasting, and Multimedia Broadcast Multicast Service (MBMS).

7. The method of claim 5, wherein the device triggering request is encapsulated such that the device triggering request message is independent of the communication protocol used to receive the device triggering request.

8. The method of claim 1, further comprising initiating a communication link to the server in response to receiving the device triggering request as defined by the service layer protocol.

9. A wireless communications apparatus for machine to machine communication, the apparatus comprising:
a receiver configured to receive a device triggering request message from a server, the device triggering request message comprising an identifier;
a processor configured to:
identify a machine to machine service layer protocol based on contents of the device triggering request message and the identifier; and
identify a sensor based at least in part on the identifier; and
a transmitter configured to send a message to the sensor as defined by the identified machine to machine service layer protocol.

10. The apparatus of claim 9, wherein the process is configured to identify the sensor based at least in part on the identifier and as defined by the machine to machine service layer protocol identified.

11. The apparatus of claim 9, further comprising a transmitter configured to send an acknowledgement of the device triggering request to the server as defined by the machine to machine service layer protocol identified.

12. The apparatus of claim 11, wherein the transmitter is configured to at least one of send the acknowledgement after receiving another acknowledgement from the sensor, send the acknowledgment before sending the device triggering request to the sensor, and adjust a timer value for sending the acknowledgment.

13. The apparatus of claim 9, wherein the device triggering request message is encapsulated in a data packet as defined by a communication protocol used to receive the device triggering request.

14. The apparatus of claim 13, wherein the communication protocol comprises at least one of an Internet protocol (IP), short-message-service (SMS), unstructured supplementary service data (USSD), CDMA2000 1x, non-access stratum (NAS) signaling, broadcast SMS, cell broadcasting, and Multimedia Broadcast Multicast Service (MBMS).

15. The apparatus of claim 13, wherein the device triggering request is encapsulated such that the device triggering request message is independent of the communication protocol used to receive the device triggering request.

16. The apparatus of claim 16, wherein the processor is further configured to initiate a communication link to the server in response to receiving the device triggering request as defined by the service layer protocol.

17. A wireless communications apparatus for machine to machine communication, the apparatus comprising:
means for receiving a device triggering request message from a server, the device triggering request message comprising an identifier;
means for identifying a machine to machine service layer protocol based on contents of the device triggering request message and the identifier;
means for identifying a sensor based at least in part on the identifier; and
means for sending a message to the sensor as defined by the identified machine to machine service layer protocol.

18. The apparatus of claim 17, wherein the means for identifying the sensor further comprises means for identifying the sensor based on the identifier and as defined by the machine to machine service layer protocol.

19. The apparatus of claim 17, further comprising means for sending an acknowledgement of the device triggering request to the server as defined by the machine to machine service layer protocol identified.

20. The apparatus of claim 19, wherein the means for sending the acknowledgement as defined by the machine to machine service layer protocol comprises at least one of means for sending the acknowledgement after receiving another acknowledgement from the sensor, means for sending the acknowledgment before sending the device triggering request to the sensor, and means for adjusting a timer value for sending the acknowledgment.

21. The apparatus of claim 17, wherein the device triggering request message is encapsulated in a data packet as defined by a communication protocol used to receive the device triggering request.

22. The apparatus of claim 21, wherein the device triggering request is encapsulated such that the device triggering request message is independent of the communication protocol used to receive the device triggering request.

23. A computer program product comprising a computer readable storage medium encoded thereon with instructions that when executed cause an apparatus to perform a method for machine to machine communication, said method comprising:
receiving a device triggering request message from a server, the device triggering request message comprising an identifier;
identifying a machine to machine service layer protocol based on contents of the device triggering request message and the identifier;
identifying a sensor based at least in part on the identifier; and
sending a message to the sensor as defined by the identified machine to machine service layer protocol.

24. The computer program product of claim 23, wherein identifying the sensor further comprises identifying the sensor based on the identifier and as defined by the machine to machine service layer protocol.

25. The computer program product of claim 23, wherein the method further comprises sending an acknowledgement of the device triggering request to the server as defined by the machine to machine service layer protocol identified, wherein sending the acknowledgement as defined by the machine to machine service layer protocol comprises at least one of sending the acknowledgement after receiving another acknowledgement from the sensor, sending the acknowledgment before sending the device triggering request to the sensor, and adjusting a timer value for sending the acknowledgment.

26. The computer program product of claim 23, wherein the device triggering request message is encapsulated in a data packet as defined by a communication protocol used to receive the device triggering request.

27. A method for machine to machine communication, the method comprising:
generating a device triggering request message, the device triggering request message comprising an identifier and comprising information indicative of a machine to machine service layer protocol used at least in part by a wireless device in communication with a sensor; and
transmitting the device triggering request message to the wireless device that is in communication with the sensor.

28. The method of claim 27, further comprising receiving an acknowledgement of the device triggering request from the wireless device as defined by the machine to machine service layer protocol identified.

29. The method of claim 27, wherein transmitting the device triggering request message comprises transmitting a data packet as defined by a communication protocol, wherein the device triggering request message is encapsulated in the data packet.

30. The method of claim 29, wherein the communication protocol comprises one of an Internet protocol (IP), short-message-service (SMS), unstructured supplementary service data (USSD), CDMA2000 1x, non-access stratum (NAS) signaling, broadcast SMS, cell broadcasting, and Multimedia Broadcast Multicast Service (MBMS).

31. The method of claim 29, wherein the device triggering request is encapsulated such that the device triggering request message is independent of the communication protocol used to transmit the device triggering request.

32. The method of claim 27, further comprising receiving a message to initiate a communication link with the sensor in response to transmitting the device triggering request.

33. A wireless communications apparatus for machine to machine communication, the apparatus comprising:
a processor configured to generate a device triggering request message, the device triggering request message comprising an identifier and comprising information indicative of a machine to machine service layer protocol used at least in part by a wireless device in communication with a sensor;
a transmitter configured to transmit the device triggering request message to the wireless device that is in communication with the sensor.

34. The apparatus of claim 33, further comprising a receiver configured to receive an acknowledgement of the device triggering request from the wireless device as defined by the machine to machine service layer protocol identified.

35. The apparatus of claim 33, wherein the transmitter is configured to transmit the device triggering request message within a data packet as defined by a communication protocol, wherein the device triggering request message is encapsulated in the data packet.

36. The apparatus of claim 35, wherein the communication protocol comprises one of an Internet protocol (IP), short-message-service (SMS), unstructured supplementary service data (USSD), CDMA2000 1x, non-access stratum (NAS) signaling, broadcast SMS, cell broadcasting, and Multimedia Broadcast Multicast Service (MBMS).

37. The apparatus of claim 35, wherein the device triggering request is encapsulated such that the device triggering request message is independent of the communication protocol used to transmit the device triggering request.

38. The apparatus of claim 33, further comprising a receiver configured to receive a message to initiate a communication link with the sensor in response to transmitting the device triggering request.

39. A wireless communications apparatus for machine to machine communication, the apparatus comprising:
means for generating a device triggering request message, the device triggering request message comprising an identifier and comprising information indicative of a machine to machine service layer protocol used at least in part by a wireless device in communication with a sensor; and
means for transmitting the device triggering request message to the wireless device that is in communication with the sensor.

40. The apparatus of claim 39, further comprising means for receiving an acknowledgement of the device triggering request from the wireless device as defined by the machine to machine service layer protocol identified.

41. The apparatus of claim 39, wherein the means for transmitting the device triggering request message comprises means for transmitting a data packet as defined by a communication protocol, wherein the device triggering request message is encapsulated in the data packet, wherein the communication protocol comprises one of an Internet protocol (IP), short-message-service (SMS), unstructured supplementary service data (USSD), CDMA2000 1x, non-access stratum (NAS) signaling, broadcast SMS, cell broadcasting, and Multimedia Broadcast Multicast Service (MBMS).

42. The apparatus of claim 41, wherein the device triggering request is encapsulated such that the device triggering request message is independent of the communication protocol used to transmit the device triggering request.

43. A computer program product comprising a computer readable storage medium encoded thereon with instructions that when executed cause an apparatus to perform a method for machine to machine communication, said method comprising:
generating a device triggering request message, the device triggering request message comprising an identifier and comprising information indicative of a machine to machine service layer protocol used at least in part by a wireless device in communication with a sensor; and
transmitting the device triggering request message to the wireless device that is in communication with the sensor.

44. The computer program product of claim 43, further comprising means for receiving an acknowledgement of the device triggering request from the wireless device as defined by the machine to machine service layer protocol identified.

45. The computer program product of claim 43, wherein the means for transmitting the device triggering request message comprises means for transmitting a data packet as defined by a communication protocol, wherein the device triggering request message is encapsulated in the data packet, wherein the communication protocol comprises one of an Internet protocol (IP), short-message-service (SMS), unstructured supplementary service data (USSD), CDMA2000 1x, non-access stratum (NAS) signaling, broadcast SMS, cell broadcasting, and Multimedia Broadcast Multicast Service (MBMS).

46. The computer program product of claim 45, wherein the device triggering request is encapsulated such that the device triggering request message is independent of the communication protocol used to transmit the device triggering request.
